(19) United States
(12) Patent Application Publication
(10) Pub. No.: US 2020/0190379 A1
(43) Pub. Date: Jun. 18, 2020

(54) RELEASABLE AGENT APPARATUS AND METHODS FOR MANUFACTURING AND USING THE SAME

(71) Applicant: Xinova, LLC, Seattle, WA (US)

(72) Inventors: Guy Fefferman, Tel Aviv (IL); Mordehai Margalit, Zichron Yaaqov (IL); Ronen Lalena, Tel Aviv (IL)

(73) Assignee: Xinova, LLC, Seattle, WA (US)

(21) Appl. No.: 16/618,015

(22) PCT Filed: Apr. 13, 2018
(86) PCT No.: PCT/US2018/027573

§ 371 Date: Nov. 27, 2019

Related U.S. Application Data
(60) Provisional application No. 62/515,936, filed on Jun. 6, 2017.

(51) Int. Cl. C09K 5/04; A23L 27/00; H05B 6/64

(52) U.S. Cl. CPC C09K 5/04; H05B 6/6494; A23L 27/72

(57) ABSTRACT

Apparatuses and methods for releasing agents are described. In some examples, apparatuses may be provided for releasing a releasable agent in a microwave. The apparatus may have a capsule at least partially containing a phase change material and a releasable agent, wherein releasable agent is configured to be released from enclosure responsive to a phase change of the phase change material. The phase change may occur responsive to heating, which may be promoted using microwave energy in some examples.

### CROSS-REFERENCE TO RELATED APPLICATION(S)

This application claims the benefit under 35 U.S.C. § 119 of the earlier filing date of U.S. Provisional Application Ser. No. 62/515,936 filed on Jun. 6, 2017.

### TECHNICAL FIELD

This disclosure relates generally to releasable agents. Examples of capsules which may contain release releasable agents, such as aroma and/or flavor agents, are described.

### BACKGROUND

Unless otherwise indicated herein, the materials described in this section are not prior art to the claims in this application and are not admitted to be prior art by inclusion in this section.

Microwaved items, such as a food product or consumer product, may include aroma or flavor materials that are volatile and lose potency over time. In some examples, the aroma or flavor material is vaporized early in the cooking or heating cycle, which may lead to a diminished smell or flavor at the end or the cooking or heating cycle.

Microwaving pre-made food products may be a convenient way of cooking and preparing food, but may lack a customizable flavor profile. The taste or aroma surrounding the microwavable pre-made food product is not customizable as in regular cooking, where a chef may simply add more of a desired flavor at a specific time to alter the final taste or aroma of the cooked food product. Furthermore, the taste and aromatic elements may lose potency over time and during the cooking cycle, as the aromatic elements may vaporize early in the microwave cooking process and the aromatics are no longer effective when the cooking process is complete. In some examples, microwaving simply allows the food product to be heated to a safe temperature range for consumption. Should the user want to alter the flavor profile, the user is required to add separate flavor components after the product has finished cooking.

### SUMMARY

In some examples, an apparatus may include a phase change material (PCM); and a carrier matrix and a releasable agent dispersed in the carrier matrix, wherein the releasable agent is configured to be released responsive to a phase change of the PCM. The carrier matrix may include calcium carbonate and the PCM may include cetyl alcohol.

In some examples, a quantity of the releasable agent released may be dependent on a power level and exposure time of an incident microwave energy delivered to the apparatus. A quantity of the releasable agent released may be dependent on the amount of energy delivered to the apparatus.

In some examples, the releasable agent may include an aroma product. In some examples, the releasable agent may include a flavor product. In some examples, the releasable agent may include a fragrance. In some examples, the apparatus may be a cosmetic product. In some examples, the apparatus may be a food product.

In some examples, the apparatus may include a susceptor that heats the PCM responsive to incident microwave energy.

In some examples, the PCM may contact a susceptor. In some examples, the PCM may include at least one of cetyl alcohol, paraffins, waxes, oils, eythitrol, and soy wax.

In some examples, the apparatus may include a shell material. The shell material may include a filler matrix. In some examples, the shell material may include a polymeric material. In some examples, a susceptor may be positioned adjacent to an internal surface of the shell material.

In some examples, the apparatus may include a thermally conductive component contacting the PCM, wherein the thermally conductive component is configured to enhance a uniformity of the temperature within the PCM. In some examples, the apparatus may include a thermally conductive component configured to disperse heat generated within the PCM responsive to an incident microwave energy.

In some examples, the apparatus may be a capsule. The carrier matrix may include calcium carbonate.

In some examples, the apparatus may include a shell material; a phase change material (PCM) at least partially positioned within the shell material; a susceptor positioned within the shell material and may be configured to heat the PCM responsive to an incident microwave energy; and a shield material may be positioned adjacent the PCM and configured to shield microwave energy and thermally conduct a heat generated in the PCM from the incident microwave energy; a releasable agent may be positioned to be at least partially shielded from the incident microwave energy by the shield material and configured to be in thermal communication with the PCM and be released responsive to the phase change of the PCM.

In some examples, the apparatus may include a susceptor positioned adjacent an internal surface of a shell material; a phase change material (PCM) at least partially contained within the shell material; and a carrier matrix and a releasable agent dispersed in the carrier matrix, wherein the releasable agent may be configured to be released responsive to a phase change of the PCM.

In some examples, the apparatus may include a phase change material (PCM); and a carrier matrix and a releasable agent dispersed in the carrier matrix, wherein the releasable agent is configured to be released responsive to a phase change of the PCM; and a thermally conductive component may be configured to disperse heat generated within the PCM responsive to an incident microwave energy.

In some examples, the apparatus to flavor a food item responsive to exposure to microwave energy may include a container with an interior surface, wherein the container may be configured to house the food item therein; a spacer with a first surface and a second surface, wherein the first surface is opposite the second surface, and the first surface of the spacer is adjacent to the interior surface of the container; and a capsule adjacent the second surface of the spacer, wherein the capsule contains a phase change material that encapsulates a flavor product. The flavor product may be released from the capsule and directed towards the food item when the phase change material is exposed to a microwave energy to cause a phase change within the phase change material. A quantity of the flavor product released may depend on a power level and an exposure time of the microwave energy delivered to the apparatus during operation.

In some examples, the apparatus may include a microwave absorption material located between the first surface of the spacer and the interior surface of the container. The capsule may include a shell material that defines an aperture and the flavor product is configured to be released from the capsule through the aperture. The apparatus may include a second capsule adjacent the second surface of the spacer. The second capsule may contain a second phase change material that encapsulates a second flavor product. The second flavor product may be released from the second capsule and directed towards the food item when the second phase change material is exposed to a second microwave energy to cause a phase change within the second phase change material. The second flavor product may be released after the flavor product is released.

In some examples, the phase change material may be selected to release the flavor product from the capsule in response to the microwave energy with the power level of at least 1000 Watts and the exposure time of at least 2 minutes. The spacer may be conductively coupled to the capsule such that thermal dissipation from the spacer to capsule occurs at a prescribed rate. The spacer may include a cardboard material. The spacer may include a material with a thermal conductivity in the range of 0.030 to 0.040 Watts/(meter-Kelvin). The spacer may be configured to absorb the microwave energy and conductively transfer an absorbed energy to the capsule.

In some examples, the capsule may be configured to absorb a convectively transferred heat from the food item. The capsule may include a microwave reflector material. The capsule may include a convective heat absorption material. The capsule may include a conductive heat absorption material. The capsule may include a material selected from amorphous polyethylene terephthalate, crystallized polyethylene terephthalate, polypropylene, metal, or combinations thereof.

In some examples, the phase change material may include a material selected from paraffin, wax, oil, or combinations thereof. The container may include a second phase change material configured to absorb the microwave energy once the food item has reached a desired temperature. A position of the flavor product within the phase change material may be selected to result in a staggered release of the flavor product responsive to the microwave energy.

In some examples, a method to manufacture a food flavoring apparatus may include forming a first capsule; filling the first capsule with a first flavor product encapsulated by a first food-grade phase change material; coupling a spacer to the first capsule; and coupling the spacer to an interior surface of a container, wherein the spacer is configured to separate the first capsule from the interior surface of the container.

In some examples, the method may include forming the spacer from cardboard. The method may include forming the first capsule from microwave reflector material. The method may include forming a second capsule; filling the second capsule with a second flavor product encapsulated by a second food-grade phase change material; and coupling the second capsule to the spacer.

In some examples, a method of preparing a food item may include placing a package including the food item and an encapsulated flavor container in a microwave oven; exposing the package to a first amount of microwave energy based on a power level and a time duration when a first flavor is desired for the food item; and exposing the package to a second amount of microwave energy based on a second power level and a second time duration when a second flavor is desired for the food item.

In some examples, exposing the package to the first amount of microwave energy may include releasing the first flavor from the encapsulated flavor container. Exposing the package to the second amount of microwave energy may include releasing the second flavor from the encapsulated flavor container. In some examples, exposing the package to the first amount of microwave energy may include displaying an indication of the first flavor on the package. Exposing the package to the second amount of microwave energy may include displaying an indication of the second flavor on the package.

In some examples, an apparatus to flavor a food item responsive to exposure to microwave energy may include a container with an interior surface, wherein the container may be configured to house the food item therein; a spacer with a first surface and a second surface, wherein the first surface is opposite the second surface, and the first surface of the spacer is adjacent to the interior surface of the container; and a pouch adjacent the second surface of the spacer and that may contain a plurality of capsules encapsulated by a phase change material, and each of the plurality of capsules contains a flavor product.

In some examples, the flavor product may be released from the pouch and directed towards the food item when the phase change material is exposed to a microwave energy based on a power level and a time duration to cause the phase change material to change phase. A quantity of the flavor product released may depend on the power level and time duration of the microwave energy delivered to the apparatus during operation.

In some examples, each of the plurality of capsules may include an inner shell that defines an inner aperture and the flavor product may be configured to be released from each capsule into the pouch through the inner aperture. The pouch may include a microwave reflector material. The pouch may have an outer shell material that defines an outer aperture and the flavor product may be configured to be released from the pouch through the outer aperture. In some examples, the apparatus may include a second phase change material that surrounds the outer shell of the pouch.

In some examples, a method to manufacture a food flavoring apparatus may include forming a plurality of capsules; filling each of the plurality of capsules with a flavor product; encapsulating each of the plurality of capsules with a food-grade phase change material; filling a pouch with the plurality of capsules; coupling a spacer to the pouch; and coupling the spacer to an interior surface of a container. The spacer may be configured to separate the pouch from the interior surface of the container.

The method may include forming the pouch with an outer shell that defines an outer aperture. The method may include forming the pouch using a microwave reflector material. In some examples, forming the plurality of capsules may further include forming an inner shell that defines an inner aperture.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1A is a perspective view of an example microwaveable food flavoring apparatus;

FIG. 1B is a cross-sectional view of the microwaveable food flavoring apparatus along line 1B-1B of FIG. 1A showing an example of a spacer with a first capsule;

FIG. 1C is a cross-sectional view of the microwaveable food flavoring apparatus along line 1C-1C of FIG. 1B showing an example of a first capsule;

FIG. 1D is a cross-sectional view of the microwaveable food flavoring apparatus along line 1D-1D of FIG. 1B showing an example of a first capsule;

FIG. 2A is a perspective view of another example microwaveable food flavoring apparatus;

FIG. 2B is a cross-sectional view of the microwaveable food flavoring apparatus along line 2B-2B of FIG. 2A showing another example of a spacer with a first capsule;

FIG. 2C is a cross-sectional view of the microwaveable food flavoring apparatus along line 2C-2C of FIG. 2B showing an example of a second capsule located within a first capsule;

FIG. 3A is a perspective view of another example microwaveable food flavoring apparatus;

FIG. 3B is a cross-sectional view of the microwaveable food flavoring apparatus along line 3B-3B of FIG. 3A showing an example of a spacer with a first capsule and a second capsule;

FIG. 3C is a cross-sectional view of the microwaveable food flavoring apparatus along line 3C-3C of FIG. 3B showing an example of a spacer with a first capsule and a second capsule;

FIG. 4A is a perspective view of another example microwaveable food flavoring apparatus;

FIG. 4B is a cross-sectional view of the example microwaveable food flavoring apparatus along line 4B-4B of FIG. 4A showing an example of a spacer with a pouch;

FIG. 4C is a cross-sectional view of the microwaveable food flavoring apparatus along line 4C-4C of FIG. 4B showing an example of a pouch containing multiple first capsules;

FIG. 5A is a perspective view of another example microwaveable food flavoring apparatus;

FIG. 5B is a cross-sectional view of the microwaveable food flavoring apparatus along line 5B-5B of FIG. 5A showing another example of a spacer with a pouch;

FIG. 5C is a cross-sectional view of the microwaveable food flavoring apparatus along line 5C-5C of FIG. 5B showing another example of a pouch containing multiple first capsules;

FIG. 6 is a flow chart describing an example method to manufacture an example of an edible item;

FIG. 7 is a flow chart describing another example method to manufacture an example of an edible item; and

FIG. 8 is a flow chart describing an example method to prepare a food item for consumption,

FIG. 9 is a cross-sectional view of an example of an apparatus;

FIG. 10 is a cross-sectional view of another example of an apparatus;

FIG. 11 is a cross-sectional view of another example of an apparatus;

FIG. 12 is a cross-sectional view of another example of a microwavable encapsulated apparatus;

FIG. 13 is a cross-sectional view of another example of an apparatus;

FIG. 14 is a cross-sectional view of another example of a microwavable encapsulated apparatus;

all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are implicitly contemplated herein.

This disclosure is drawn, inter alia, to methods, systems, products, devices, and/or apparatus generally related to an encapsulated or releasable agent that may have a flavor, aroma, fragrance, color or combinations thereof, that may be released during a heating or cooking cycle. In some examples, the heating or cooking cycle may be accomplished in a microwave, a convection or conduction oven, an electrical heating device, or similar device. In some examples, the releasable agent may be heat sensitive or volatile, and is included within a microwaveable or heated apparatus such as a capsule and is releasable responsive to incident heat, such as microwave energy. In some examples, the capsule includes a delayed release mechanism to enable a controlled release of the releasable agent towards the end of the cooking or heating cycle. In some examples, the releasable agent may be released a few seconds before the end of the cooking or heating cycle. In some examples, the releasable agent may be released when a food item or consumer product is heated to a specific temperature. In examples where a controlled release of the releasable agent is not used, the releasable agent may be prematurely dispersed or damaged during the heating or cooking process.

In some examples, the releasable agent may have a flavor, fragrance, aroma, color, or combinations thereof and may be used to flavor, enhance or change the aroma, flavor, fragrance, or appearance of a food item or a consumer product.

In some examples, the apparatus may be a microwavable encapsulated apparatus. In some examples, the apparatus is a capsule that may include a shell material, a phase change material (PCM), a susceptor, and a releasable agent.

In some examples, the capsule, which may include the PCM and releasable agent, may be designed to control specific release conditions of the capsule contents such as controlling the release timing, the temperature prior to or during the release, or the heating rate of the capsule and its contents.

In some examples, the capsules may be spread upon or adjacent a microwavable object or object that may be heated using other techniques, such as a food item or consumer product item. In some examples, the capsule is mounted over or inside a microwavable food package or consumer product package. In some examples, the capsule is embedded within a package wall or the content of the capsule is located in a cavity in the package wall. In some examples, the capsule is positioned within a segregated compartment that may help reduce the occurrence of food contamination in case the capsule accidentally ruptures and the possible leakage of the PCM may occur. In some examples, the capsule may be placed, coupled to, attached, or positioned within or adjacent a package formed of modified film-forming celluloses, such as ethyl cellulose, CMC, cellulose acetate, etc.; synthetic polymers such as PET, PET copolymers, polyethylene, polypropylene and its copolymers; acrylic/acrylate polymers and its copolymers, etc.

In some examples, the filling and sealing of the capsule may utilize pharmaceutical industry manufacturing techniques. In some examples, the capsule has a shape of a pouch, and the manufacturing and filling of the capsule is done using a vertical form fill seal (VFFS) machine.

In some examples, the capsule has an outer layer or portion that includes a shell material.

The shell material may be formed from an edible polymer, such as a hard gelatin. In some examples, the shell material may be at least partially formed with a microwave absorbing material, such as a thin aluminum layer. In such examples, the shell material may act at least partially as a susceptor. In some examples, the shell material may be cardboard.

In some examples, the shell material is formed using a blow molding manufacturing technique. In some examples, the shell material is formed using a plastic injection molding manufacturing technique.

In some examples, the shell material's material type, mass, and/or size may be designed to control specific required release conditions of the releasable agent. In some examples, the shell material may be designed to have an engineered failure mechanism or a weak spot, such as an area with a lower or smaller wall thickness, a seal with a decreased strength, etc., so that the shell material may release its contents through it under the predefined conditions.

The shell material may at least partially enclose a PCM. In some examples, the capsule is filled with the PCM. A PCM may be a heat or energy absorbing material.

In some examples, the PCM is a Generally Recognized as Safe (GRAS) material or a food grade material. In some examples, the PCM is allitol, animal oils, beeswax, candelilla wax, carnauba wax, clarified butter, cocoa butter, coconut butter, erythritol, glactitol, glucose, plant oils, rice bran wax, sorbitol, soy wax, sucrose, sunflower wax, xylitol, (or any combination of those materials). In some examples, cetyl alcohol is used as a PCM. In some examples, the PCM is water; an edible oil with a melting point below ambient temperature; a paraffin or paraffin-based mixture; fatty acids, alcohols, and their derivatives or mixtures; or sugar alcohols and their derivatives or mixtures.

In some examples, the PCM is in a liquid or powder form. In such examples, the handling of the PCM during manufacturing of the apparatus may be simpler, as the PCM in the form of a liquid or powder may be pumped, injected or inserted into the capsule.

In some examples, the PCM controls and regulates the temperature of releasable agent for the delayed release. In some examples, the PCM helps prevents or protect the releasable agent from overheating or evaporation during the heating or cooking process. In some examples, the PCM is formed from a material that may absorb a large amount of energy relative to its mass. In some examples, the PCM is formed from a material that is not heated by microwaves when in a solid phase.

In some examples, the PCM may be a material that undergoes a phase change, for example from a solid state to a liquid state, during the heating or cooking process of the capsule. In some examples, the thickness and thermal properties of the PCM help define the amount of energy that will be absorbed by the PCM before its phase change starts. When a PCM reaches the temperature at which a phase change occurs, for example a melting temperature, the PCM absorbs large amounts of heat or energy at a constant temperature. The PCM may continue to absorb heat or energy without a significant rise in temperature until all or nearly all of the PCM has changed phase. In some examples, a PCM with an increased mass will have a reduced heating rate. In some examples, reducing the heating or microwave cooking power reduces the heating rate of the PCM. In some examples, the amount and the thermal properties of the PCM will provide a different release profiles of the releasable agent for different target temperatures.

In some examples, after the heating or cooking cycle has completed, the PCM may begin to solidify. The PCM may begin the release of the latent heat in the PCM in the process of phase change reversal to a solid. This may allow for a continued release of the releasable agent that may last during the time in which the PCM solidifies. This may help extend the release of the releasable agent and provide a longer-lasting effect of the releasable agent.

The PCM may also protect a product during its shelf life, for example from oxidation during storing. In some examples, the PCM type and mass may be designed to control specific required release conditions of the releasable agent.

In some examples, the capsule is not filled with a PCM or it is filled with a non PCM liquid or solid. In such examples, the sealing of the capsule may prevent the releasable agent from evaporating during the cooking or heating cycle or process. When the capsule is breached such as through a rupture, split seam, engineering failure mechanism, the releasable agent is released. Some example apparatus may comprise a shell material, and a releasable agent at least partially enclosed by the shell material and configured to be released from enclosure by the shell material responsive to incident heat from a heating source or microwave radiation from a microwave. In some examples, the shell material may be configured to at least partially melt, soften, rupture, or otherwise show appreciably reduced mechanical integrity in response to incident heat or microwave energy (for example, in response to heating of the shell material or a material proximate to the shell material by incident heat or microwave energy.) In some examples, the apparatus includes a susceptor.

In some examples, the capsule includes a susceptor, which may be a microwave or heat or energy absorbing material. In some examples, the susceptor is positioned within the capsule. In some examples, a food product or consumer product may act as a susceptor and be positioned outside of the capsule.

In some examples, the susceptor may be formed with a susceptor foil. In some examples, the susceptor may be formed using an edible heat, energy, or microwave absorbing material. Examples of edible heat, energy, or microwave absorbing food additives include calcium carbonate (E170), calcium oxide (E529), carbon black (E153), iron composites, iron oxide (E172), magnesium oxide (E530), titanium dioxide (E171), and water. In some examples, an edible heat, energy, or microwave absorbing food additive may be in powdered or liquid form and can be mixed with the PCM and releasable agent. In some examples, these materials may easily be handled using normal equipment without the special care needed to handle a susceptor foil, such as when the susceptor is formed of foil.

In some examples, the susceptor is formed of aluminum layer deposited over a PET foil. In the examples where the susceptor is an aluminum layer deposited over a PET foil, the susceptor may be delicate and utilize special handling and loading process into the shell or apparatus.

In some examples, the susceptor may help trigger and promote the phase change of the PCM. In some examples, the PCM does not absorb microwaves in its solid phase but does absorb microwaves and heat in its liquid phase, so that only a small amount of a susceptor is needed to trigger and start the PCM phase change process. In some examples, the susceptor type, mass, and/or size may be designed to control specific required release conditions of the releasable agent.

In some examples, the capsule includes a releasable agent positioned within the capsule. In some examples, the releasable agent is encapsulated or embedded together or separately in or with the PCM. In some examples, the releasable agent and the PCM are confined in a carrier matrix that helps form the capsule. In some examples, the releasable agent is combined with a carrier matrix to form a core, and the PCM may be located outside of or surround the core so that the PCM is entrapped in the shell material.

In some examples, the releasable agent may have a flavor, fragrance, aroma, color or combinations thereof. In some examples, the releasable agent may include flavorant components such as capsaicin, vanillin, salts (such as sodium chloride), acids (such as citric acid, acetic acid), etc. In some examples, the releasable agent may be an aroma product or a flavor product. In some examples, the releasable agent may be in the form of aroma product or a flavor that is salty; spicy in the form of black pepper, buffalo sauce, cayenne pepper, chili, curry, red pepper, salsa, or the like; sweet in the form of agave, honey, sugar, or the like; or have the general characteristic of a spice including balsamic vinegar, butter, butter flavor acetoin, basil, bay leaf, celery seed, chives, cilantro, cinnamon, cloves, coriander, cumin, dill, dill seed, fennel, garlic, ginger, grapefruit, lavender, lemon, lemongrass, marjoram, mint, mustard, nutmeg, olive oil, orange, oregano, paprika, parsley, peppermint, poppy seeds, poultry seasoning, rosemary, sage, saffron, star anise, sesame seed, tarragon, turmeric, thyme, or other citrus flavors or aromas, floral flavors or aromas, etc. In some examples, the releasable agent is a health product such as a polyunsaturated oil, such as fish oils, flaxseed oil, or microalgae oils.

In some examples, the releasable agent is in a liquid or powder form. In such examples, the handling of the releasable agent during manufacturing of the apparatus may be simpler, as the releasable agent in the form of a liquid or powder may be pumped, injected or inserted into the capsule.

In examples where the releasable agent is a polyunsaturated oil, the use of a polyunsaturated oil may benefit from the use of the apparatus to help prevent the off-taste (rancidity) that may develop during the shelf like of the polyunsaturated oil. This taste may be a result of fat oxidation over time from exposure to oxygen and other ingredients. Filling the capsule with a releasable agent such as a polyunsaturated oil may help protect the releasable agent from oxidation during shelf life and may help enable releasing the releasable agent onto a food product or consumer product after a predefined cooking or heating time.

Various examples of apparatus, such as capsules, will now be described.

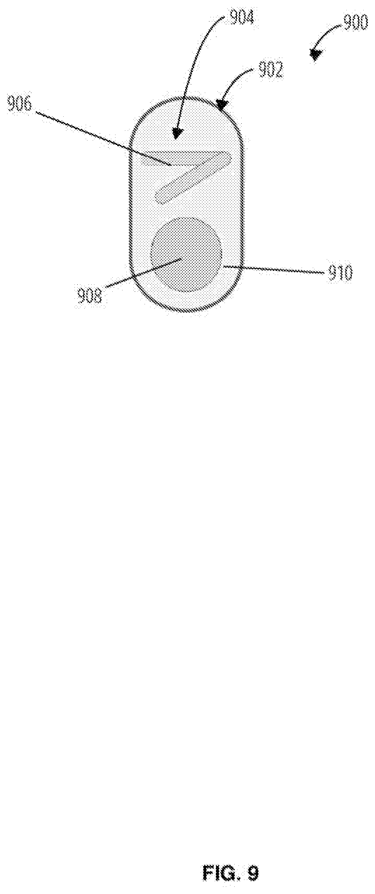

FIG. 9 illustrates a capsule 900 in accordance with one embodiment. FIG. 9 shows a capsule 900, a shell material 902, with a PCM 904, a susceptor 906, a releasable agent 908, and a releasable agent container 910. The various components described in FIG. 9 are merely examples, and other variations, including eliminating components, combining components, adding components, and substituting components are all contemplated.

In some examples, the capsule 900 may be an apparatus or a microwavable encapsulated apparatus. In some examples, the shell material 902 encapsulates the PCM 904, the susceptor 906, and the releasable agent 908. In some examples, releasable agent 908 is an aroma product. In some examples, the releasable agent 908 is a flavor product. In some examples, the shell material 902 is made of a polymer, such as LDPE, PP, or PET. In some examples, the shell material 902 encapsulates the PCM 904, the susceptor 906, and the releasable agent 908 for delayed release.

In some examples, the PCM 904 provides the encapsulation of the releasable agent 908. In an example, the releasable agent 908 may be contained within the releasable agent container 910. In some examples, the releasable agent container 910 is formed by the outer surface or perimeter of the releasable agent 908 so that the releasable agent container 910 and releasable agent 908 are formed from the same material.

In an example, during a conduction, convection, or microwave heating process, the susceptor 906 is heated by energy or microwaves transmitted within the heating element or microwave and promotes a phase change of the PCM 904. In some examples, this phase change is from a solid to a liquid, such that the PCM 904 may be considered to melt. In some examples, as the PCM 904 changes phase, the temperature of the releasable agent container 910 increases until a predetermined temperature is reached. At this predetermined temperature, a portion of the releasable agent container 910 may be break or separate, such as by a separation method that may include punching, cracking, melting, etc. and the releasable agent 908 is released. In some examples, the releasable agent container 910 may be designed to release its contents under predefined or controlled conditions such as a temperature or cooking duration. In some examples, the releasable agent container 910 may be designed to release its contents at the end of a cooking or heating process or cycle.

Some example apparatus may comprise a shell material, a material at least partially enclosed by the shell material and configured to change phase responsive to incident heat or microwave energy, and a releasable agent at least partially enclosed by the shell material and configured to be released from enclosure responsive to the phase change of the material. In some examples, the shell material may be configured to at least partially melt, soften, rupture, or otherwise show appreciably reduced mechanical integrity in response to incident microwave energy (for example, in response to local heating of an enclosed material induced by incident microwave energy.)

Some example apparatus may include a shell material, a PCM at least partially enclosed by the shell material and configured to change phase responsive to incident microwave energy, and a releasable agent at least partially enclosed by the shell material and configured to be released from enclosure responsive to the phase change of the PCM. In some examples, the PCM and/or the shell material may have appreciable absorption of microwave energy. In some examples, an additional susceptor may be included.

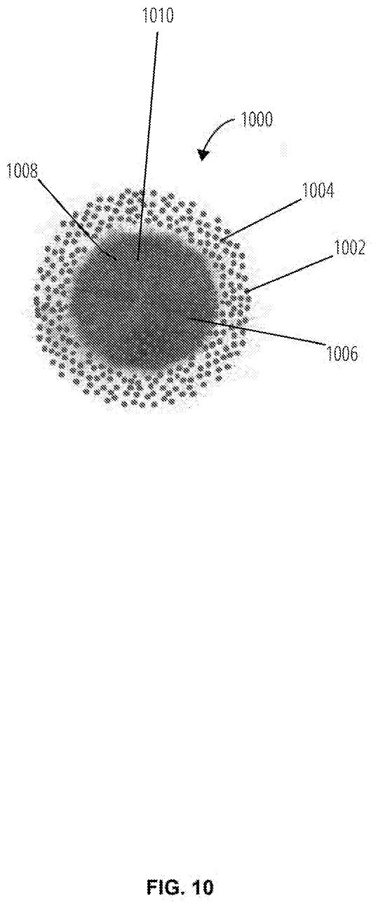

FIG. 10 illustrates a capsule 1000 in accordance with one embodiment. The capsule 1000 includes a shell material 1002, a PCM 1004, a carrier matrix 1006, a releasable agent 1008, and a core 1010. The various components described in FIG. 10 are merely examples, and other variations, including eliminating components, combining components, adding components, and substituting components are all contemplated.

In some examples, the capsule 1000 may be an apparatus or a microwavable encapsulated apparatus. In some examples, the core 1010 may be formed of the carrier matrix 1006 and the PCM 1004. The PCM 1004 may be entrapped within the shell material 1002 that surrounds the core 1010. The releasable agent 1008 may be contained or mixed within the carrier matrix 1006, which may be a porous carrier such as calcium carbonate. The core 1010 may then be coated by a layer of the PCM 1004.

In some examples, the carrier matrix 1006 is calcium carbonate and is saturated with the releasable agent 1008. In some examples, the releasable agent 1008 is emulsified and subsequently covered with a coating of the carrier matrix 1006.

In some examples, cetyl alcohol may have a low thermal conductivity, while calcium carbonate may have a high thermal conductivity. The combination of using cetyl alcohol as the PCM 1004 and using calcium carbonate as the carrier matrix 1006 may help enhance the efficiency, such as increase the thermal conductivity, of the cetyl alcohol for use in the capsule 1000.

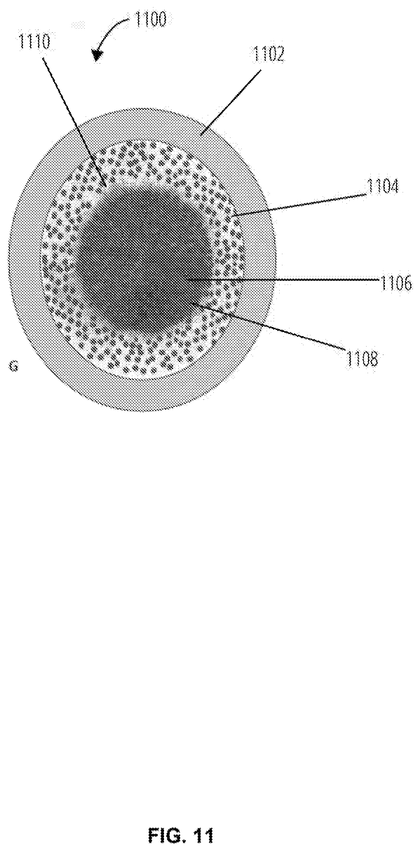

FIG. 11 illustrates a capsule 1100 in accordance with one embodiment. The capsule 1100 includes a shell material 1102, a PCM 1104, a carrier matrix 1106, a releasable agent 1108, and a core 1110. The various components described in FIG. 11 are merely examples, and other variations, including eliminating components, combining components, adding components, and substituting components are all contemplated.

In some examples, the capsule 1100 may be an apparatus or a microwavable encapsulated apparatus. As shown in FIG. 11, the core 1110 may be formed with the releasable agent 1108 contained within the carrier matrix 1106, which may be a porous carrier such as calcium carbonate. The core 1110 may then be coated by a layer of the PCM 1104, which may be cetyl alcohol. Cetyl alcohol may have a low thermal conductivity, while calcium carbonate may have a high thermal conductivity. The combination of using cetyl alcohol as the PCM 1104 and using calcium carbonate as the carrier matrix 1106 may help enhance the efficiency of the cetyl alcohol for use in the capsule 1100.

In some examples, the carrier matrix 1106 may work with food quality PCM such as waters, sugars, long chain fatty acids and alcohols. In some examples, water-soluble PCM are not suitable for use with a carrier matrix 1106 such as calcium carbonate, and therefore a hydrophobic PCM may be desired.

As shown in FIG. 11, the PCM 1104 may be surrounded by the shell material 1102 made of polymeric filler. The polymeric filler may be formed using polysaccharides and their derivatives, such as glucomannan, pectin, gelatin, etc.; natural waxes and starches, such as gum Arabic, modified starches, etc., synthetic polymers, such as PVP, PVA, PMMA, cellulose and its derivatives, or various combinations thereof. This embodiment may allow the releasable agent 1108 to have a free-flowing like capability

In some examples, the shell material 1102 may be made of cellulose based polymer, and synthetically modified derivatives. In some examples, shell material 1102 may be made of polymer material; a polysaccharides and their derivatives, such as glucomannan, pectin, gelatin, etc.; natural waxes and starches such as gum arabic, modified starches, etc.; cellulose acetate (CeA); ethyl cellulose (EC); cellulose acetate phthalate (CAP); polyvinylpyrrolidone (PVP); polycaprolactone (PCL), polymethylmethacrylate (PMMA), polyvinyl alcohol (PVA), cellulose or its derivatives, or combinations thereof.

In some examples, using the shell material 1102 to surround the PCM 1104, such as that for capsule 1100, may help provide a longer or delayed release of the releasable agent 1108, as the vapors will need more time for penetration through the shell material 1102. Also, using the shell material 1102 to surround the PCM 1104 as in the capsule 1100 may help prevent leakage of the PCM 1104.

The shell material 1102 may be applied to the PCM 1104 using spray drying or a fluidized bed process. In some examples, the shell material 1102 may be formed as a free-flowing powder. This may allow the capsule 1100 to be used with a pouch or sachet type holder, such as a loose mesh extraction type bag made from polyolefin mixture. The pouch or sachet may be durable yet freely permeable for gases and liquids. In some examples the use of the pouch or sachet type holder may allow the capsule 1100 to be placed within the pouch or sachet so that the releasable agent 1108 may be easily released as a vapor so that its aroma or flavor may emanate freely, but the capsule 1100 may be contained as the pouch or sachet did not lose its integrity or mesh structure during the heating, cooking, or microwave heating or cooking process.

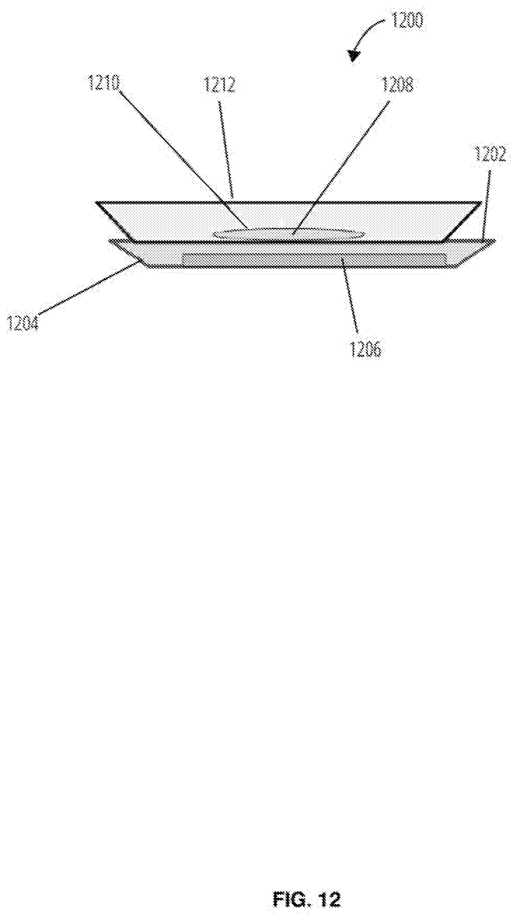

FIG. 12 illustrates a capsule 1200 in accordance with one embodiment. The capsule 1200 includes a shell material 1202, a PCM 1204, a susceptor 1206, a releasable agent 1208, and a shield material 1212. The various components described in FIG. 12 are merely examples, and other variations, including eliminating components, combining components, adding components, and substituting components are all contemplated.

In some examples, the capsule 1200 may be an apparatus or a microwavable encapsulated apparatus. In some examples, the capsule 1200 may also be referred to as an aroma or flavor “candle.” In some examples, the position of the shield material 1212 may act as an efficient heat conductor and influence or effect the dispersion of heat within the capsule 1200 and the heat which is eventually transferred to the releasable agent 1208. In some examples, the shield material 1212 may act as a cooling element. In some examples, the shield material 1212 may be formed as a second cup that is positioned on top of or adjacent the shell material 1202. In some examples, the shield material 1212 may help so that the releasable agent 1208 of the capsule 1200 may be heated only by conduction from the PCM. In some examples, the shield material 1212 may help prevent heat, such as convective or conductive heat, energy, or microwaves from being transmitted to or to heat the releasable agent 1208.

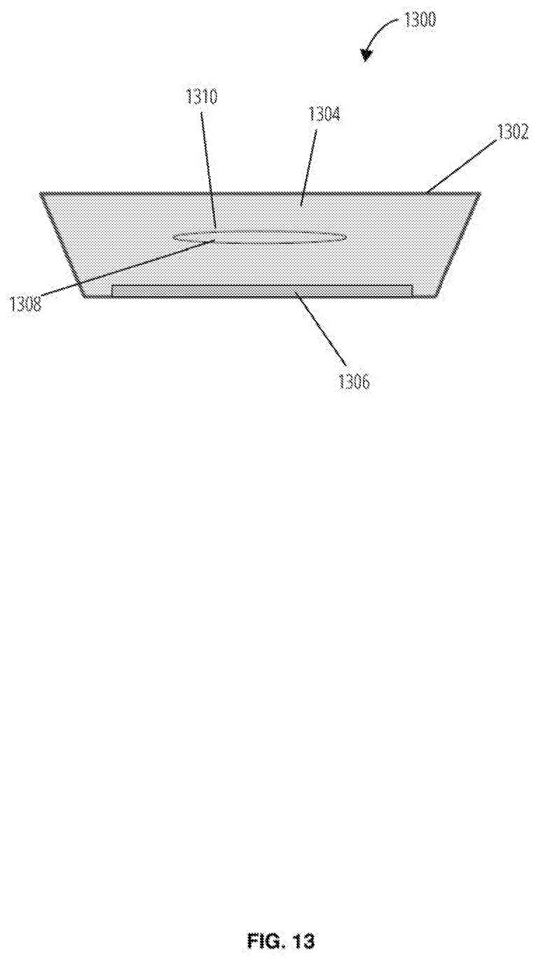

FIG. 13 illustrates a capsule 1300 in accordance with one embodiment. The capsule 1300 includes a shell material 1302, a PCM 1304, a susceptor 1306, a releasable agent 1308, and a releasable agent container 1310. The various components described in FIG. 13 are merely examples, and other variations, including eliminating components, combining components, adding components, and substituting components are all contemplated.

In some examples, the capsule 1300 may be an apparatus or a microwavable encapsulated apparatus. In some examples, the capsule 1300 may control the release timing and temperature of the releasable agent 1308 during the conductive or convective heating, cooking, or microwave heating or cooking process.

In an example, the shell material 1302 includes plastic or cardboard. In some examples, the releasable agent 1308 may be positioned within the releasable agent container 1310. In some examples, the releasable agent container 1310 is a sealed bag, such as an LDPE bag, which is then placed in the PCM 1304. The releasable agent container 1310 may prevent the releasable agent 1308 from evaporating. The PCM 1304 may help regulate the releasable agent temperature during the microwave cooking or heating process and set the release time delay. When the PCM 1304 begins to change phase and start to heat, it may locally melt the releasable agent container 1310, such that the bag, or a glue that seals the bag, melts or becomes damaged and the releasable agent 1308 is released from the releasable agent container 1310 and may begin to evaporate.

In some examples, the releasable agent container 1310 is formed by the outer surface or perimeter of the releasable agent 1308 so that the releasable agent container 1310 and releasable agent 1308 are formed from the same material.

In some examples, the capsule 1300 may be a micro cup. In some examples, the micro cup is designed to release its contents under predefined controlled conditions such as temperature or cooking duration. In some examples, the micro cup releases the releasable agent 1308 at the end of the cooking or heating process.

In some examples, the capsule 1300 includes edible heat, energy, or microwave absorbing materials that may act as the susceptor 1306. In some examples, the edible microwave absorbing materials may act as an additional susceptor to the susceptor 1306.

In some examples, a material with a low thermal conductivity may be placed between the susceptor 1306 and the releasable agent 1308, such that the material acts as a thermal resistor and reduces the heating rate of the PCM 1304 and the releasable agent 1308. In some examples, the material is a Polyamide layer with a thickness of about 0.5-1 mm thick or the material is a cardboard layer.

In some examples, the capsule 1300 is mounted over or inside of a microwaveable food snack product or consumer product. In some examples, the capsule 1300 is loaded into a cavity of the packaging wall of the microwaveable food snack product or consumer product.

In an example, the PCM 1304 surrounds or encapsulate the releasable agent 1308.

In some examples, the capsule 1300 may be manufactured in a variety of manufacturing processes. In an example, the capsule 1300 is injection molded from a suitable PCM material, and the releasable agent 1308 is injected into the capsule 1300 and the injection hole is sealed by heat. In another example, the susceptor 1306 is formed when material to form the susceptor 1306 is introduced during the injection molding. In other examples, the susceptor 1306 is attached to the capsule 1300 after the molding process.

In some examples, the capsule 1300 may be introduced during a packaging process using a dedicated deposition nozzle. In an example, the deposition nozzle may move in horizontal and vertical planes, similar to a 3D printer. The nozzle deposits a layer of the PCM 1304 into a suitable location in the package. In an example, the package includes a recess for the capsule 1300 and the nozzle deposits the PCM 1304 into the recess. A second nozzle or dispenser deposits the releasable agent 1308 on top of the PCM 1304, and the first nozzle then covers the releasable agent 1308 with a PCM 1304 layer. The susceptor 1306 may be added after the first layer of PCM 1304 is deposited and then a second layer of PCM 1304 is deposited.

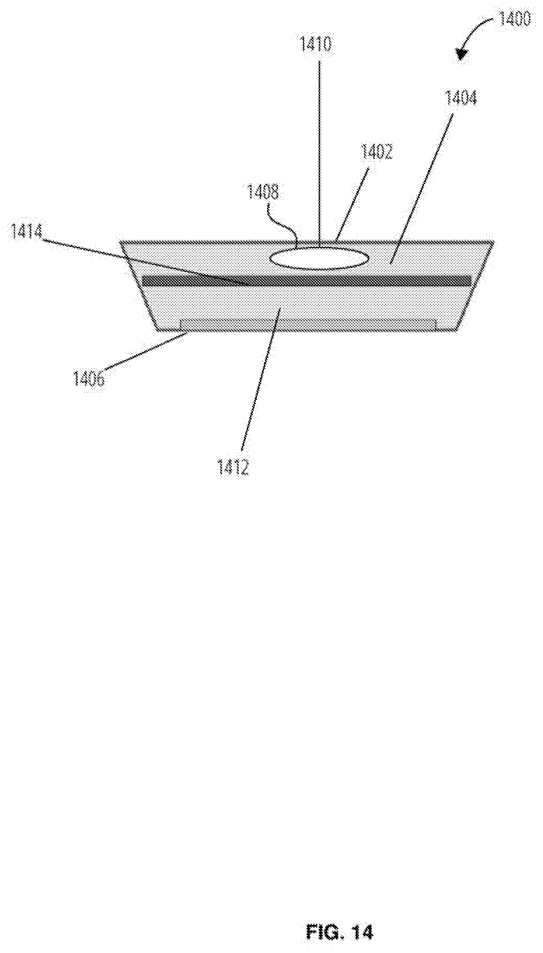

FIG. 14 illustrates a capsule 1400 in accordance with one embodiment. The capsule 1400 includes a shell material 1402, a PCM 1404, a susceptor 1406, a releasable agent 1408, a releasable agent container 1410, a PCM 1412, and a thermally conductive component 1414. The various components described in FIG. 14 are merely examples, and other variations, including eliminating components, combining components, adding components, and substituting components are all contemplated.

In some examples, the capsule 1400 may be an apparatus or a microwavable encapsulated apparatus. In some examples, positioning the thermally conductive component 1414 within the PCM 1404, adjacent the PCM 1404, or between PCMs 1404 and 1412 may enhance the uniformity of the PCM phase change process. In some examples, the thermally conductive component 1414 may disperse the local heat within the PCM and prevent “hot spots.” The thermally conductive component 1410 may help create a more uniform surface temperature of the PCM 1404. This may also prevent a liquid PCM 1404 from reaching the surface or outer perimeter of the shell material 1402.

In some examples, the thermally conductive component 1414 may reduce the heating rate of the PCM 1404. In some examples, the thermally conductive component 1414 may be replaced with a thermal resistor. In these examples, the overall heating rate of the PCM 1410 may be reduced. In some examples, the thermal resistor may be a 1 mm thick Polyamide layer or a cardboard layer.

In some examples, the releasable agent container 1410 is formed by the outer surface or perimeter of the releasable agent 1408 so that the releasable agent container 1410 and releasable agent 1408 are formed from the same material.

Accordingly, a variety of capsules and method for forming capsules are described herein. The capsules may contain a releasable agent and may release the releasable agent responsive to a phase change in a phase change material. In some examples, the releasable agent may be released responsive to a temperature change in a surrounding or adjacent component or apparatus. In some examples, the releasable agent may be a flavoring, and examples are described of methods, apparatuses for flavoring food. In some examples, the releasable agent may be considered a flavor product, but other releasable agents are contemplated and may be used. In some examples, the releasable agent is a food product, a food flavoring product, an aroma product, a coloring product, or combinations thereof.

In some examples, apparatuses and methods for flavoring food in a microwave may have a container configured to house at least one edible item and having a flavor product encapsulated by a phase change material, wherein the flavor product is configured to be directed towards the edible item or away from the container when microwave energy is transferred to the phase change material causing it to change phase.

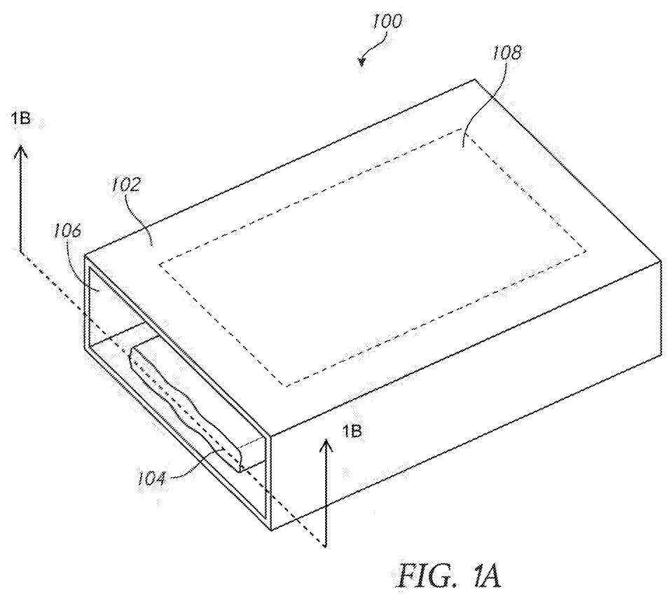

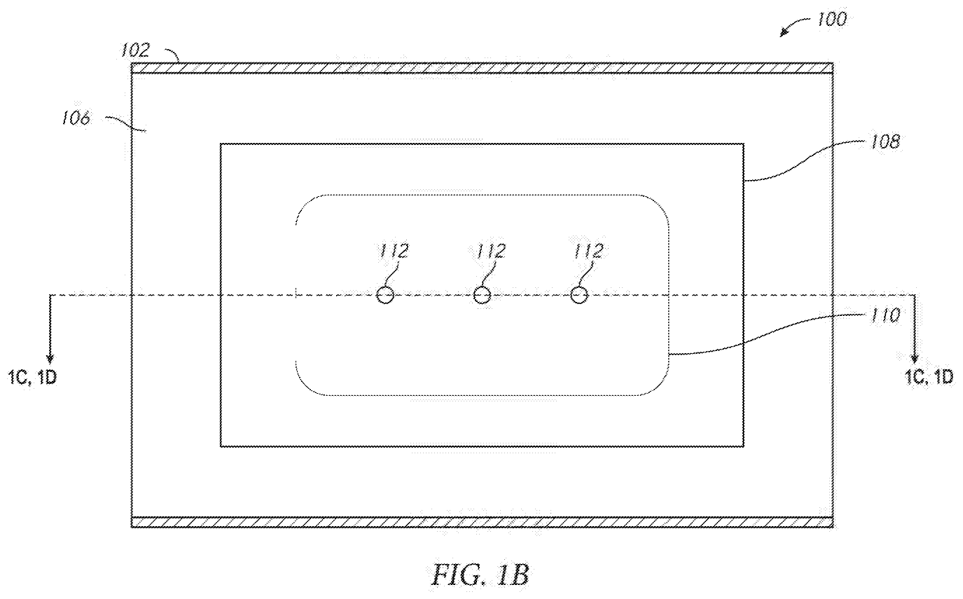

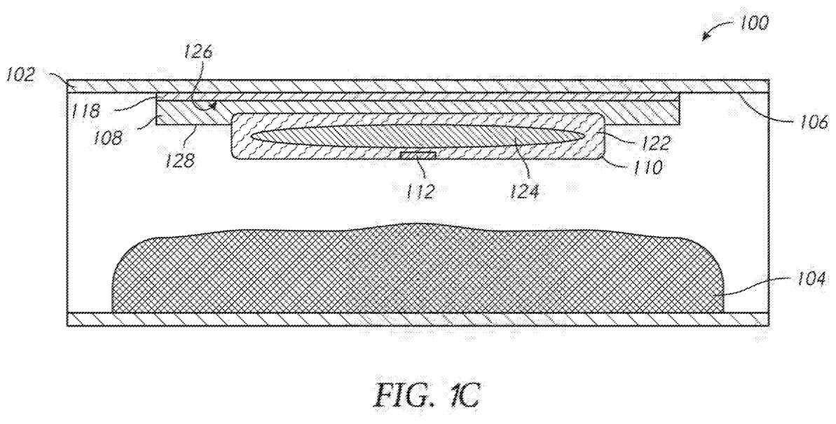

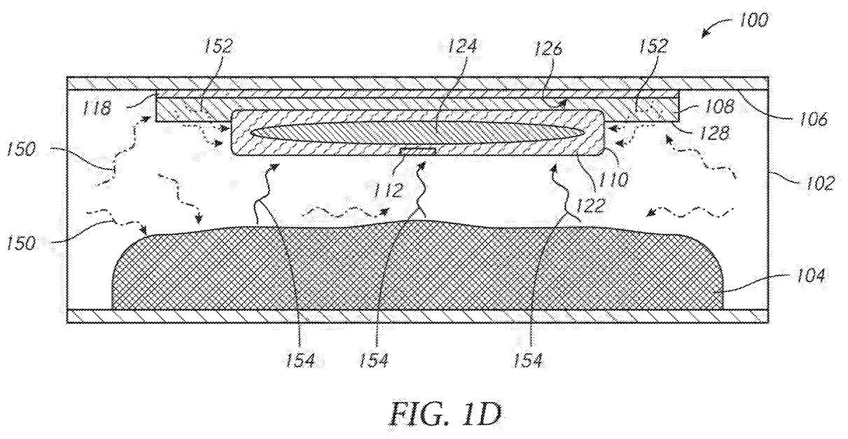

FIG. 1A is a perspective view of an example microwaveable food flavoring apparatus. FIG. 1 shows a microwaveable food flavoring apparatus 100; a container 102 with an interior surface 106; an edible item 104; and a spacer 108. The various components described in FIG. 1 are merely examples, and other variations, including eliminating components, combining components, adding components, and substituting components are all contemplated.

In some examples, a microwaveable food flavoring apparatus 100 may include a container 102 with an interior surface 106. A microwaveable edible item 104 may be located inside the container 102. A spacer 108 may also be located inside the container 102, attached to the interior surface 106 of the container 102. In some examples, the container 102 may be at least partially made from paper packaging.

In various examples, the spacer 108 may be a susceptor. In cooking or microwave cooking, susceptors may be built into a paper packaging container of a microwavable edible item. The susceptor absorbs energy from microwaves that penetrate the container when the container and the microwavable edible item are exposed to microwave radiation (e.g., when placed in a microwave oven). The process of absorbing energy from the microwaves raises the susceptor's temperature, which may then heat the microwavable edible item or another component of the apparatus 100 by conduction or convection. The susceptor may act as a starter that heats a material adjacent to the susceptor. Heating by conduction may occur when the microwavable edible item directly contacts the susceptor. Heating by convection may occur when the microwavable edible item doesn't directly contact the susceptor, but the air around the susceptor is heated, which then contacts the microwavable edible item.

In some examples, the spacer 108 may include a cardboard material, such as thin cardboard, porous cardboard, etc. In some other examples, the spacer may be made from a material with a thermal conductivity that is in a conductivity range of about 0.030 to 0.040 Watts/(meter-Kelvin). In some additional examples, the spacer may be made from a material with a thermal conductivity of about 0.037 Watts/(meter-Kelvin). In some examples, the spacer 108 may be have a surface area in the range of 100 to 1500 mm².

In some further examples, the container 102 may also contain a component configured to absorb microwave energy once the edible item 104 has reached a desired temperature, thereby at least partially preventing the edible item 104 from being overheated or overcooked. In various examples, the component configured to absorb microwave energy may include a phase change material.

FIG. 1B is a cross-sectional view of the microwaveable food flavoring apparatus along line 1B-1B of FIG. 1A showing an example of a spacer with a first capsule. FIG. 1B shows a microwaveable food flavoring apparatus 100 with an interior surface 106 of a container 102; a spacer 108; a first capsule 110 with apertures 112. The various components described in FIG. 1B are merely examples, and other variations, including eliminating components, combining components, adding components, and substituting components are all contemplated.

In some examples, the at least one capsule 110 may be at least partially made of a food grade microwave reflector material. Examples of microwave reflector material may include certain plastics such as amorphous polyethylene terephthalate, crystallized polyethylene terephthalate, polypropylene, and certain metals such as aluminum and alloys thereof, etc. The first capsule 110 may include a microwave reflector material or a material in which microwaves do not penetrate. The selection of the material for the flint capsule 110 may include a material that protects a product within the first capsule 110 from exposure to microwaves formed during the operation of a microwave. This protection may prevent or reduce the unintentional heating of a product contained within the first capsule 110 when the container 102 is placed inside the microwave to heat or cook the microwaveable edible item 104. The apertures 112 of the capsule 110 may allow the release of a product stored within the capsule 110 upon the proper heating of the capsule 110 through convective or conductive heating. The spacing of the apertures 112 may prevent some or all of the microwave radiation emitted when the microwave is operated from penetrating the product contained within the first capsule 110.

In some examples, the first capsule 110 may have a smaller cross sectional area than that of the spacer 108 when attached to the interior surface 106 of the container 102. In some examples, the first capsule 110 and the spacer 108 may have similar cross sectional areas.

In some examples, the spacer 108 has a thermal resistance and capacitance such that conductive heat dissipation between the spacer 108 and the capsule 110 occurs at a prescribed rate. In some examples, the spacer 108 may absorb the microwave energy and conductively transfer the absorbed energy to the capsule 110. In some examples, the edible item 104 may absorb the microwave energy and convectively transfer the absorbed energy to the capsule 110.

FIG. 1C is a cross-sectional view of the microwaveable food flavoring apparatus along line 1C-1C of FIG. 1B showing an example of a first capsule. FIG. 1C shows a microwaveable food flavoring apparatus 100 with a container 102 with an interior surface 106; an edible item 104; a microwave absorption material 118; a spacer 108 with a first surface 126 and a second surface 128; a first capsule 110 with an aperture 112; a phase change material 122; and a flavor product 124. The various components described in FIG. 1C are merely examples, and other variations, including eliminating components, combining components, adding components, and substituting components are all contemplated.

In some examples, the spacer 108 may have a first surface adjacent the interior surface 106 of the container. In some examples, a microwave absorption material 118 may be located between the spacer's first surface 126 and the interior surface 106 of the container 102. The microwave absorption material 118 may absorb microwaves, which may cause the increase in temperature of the microwave absorption material 118. The increased temperature of the microwave absorption material 118 may then conductively heat or increase the temperature of the spacer 108 through the direct contact of the microwave absorption material 118 and the first surface 126 of the spacer 108.

In some examples, the first capsule 110 may be adjacent the second surface 128 of the spacer 108. In an example, the first capsule 110 may contain a phase change material (PCM) 122 and a flavor product 124. The PCM 122 may absorb convective and conductive heat directed towards the first capsule 110 and thereby transfer heat to the PCM 122.

In some examples, the PCM 122 may be a substance with a high heat of fusion which changes phase by melting and solidifying at a certain temperatures, and is also capable of storing and releasing large amounts of energy. In some examples, when a PCM reaches its phase change or melting temperature, it may absorb large amounts of heat at a constant temperature as the PCM changes from a solid to a liquid. The PCM continues to absorb heat without a significant rise in its temperature until all the material is transformed to the liquid phase. PCMs with a melting temperature higher than 190° C. are commercially available.

In some examples, a PCM can act as an energy limiting susceptor, where the susceptor limits the amount of energy/temperature the microwaveable edible item may be exposed to during the cooking. For example, a PCM may help protect a microwaveable edible item from overcooking during the microwaving process by absorption excess microwaveable radiation. Examples of PCMs which may be used in examples described herein, include, but are not limited to paraffins, waxes, oils, erythritol, soy wax, and combinations thereof. In some examples, the weight of PCM may be in the range of 10 to 50 grams. In some examples, the PCM may have a cross-sectional thickness between 3 mm and 20 mm.

In some examples, a PCM may be microencapsulated to prevent leakage and can be embedded in a structure, for example plastic, paper, microfibrous structure, or matrix, used to form the container. The use of a low cost PCM as part of the apparatus 100 may help decrease the overall cost of producing the food item while also potentially regulating the heating process that is not dependent on the properties of the microwave oven being used to heat or cook the microwaveable edible item.

Accordingly, in some examples, an apparatus 100 to flavor a food item responsive to microwave energy may have a container 102 with an interior surface 106, wherein the container may be configured to house at least one microwavable edible item 104. The apparatus may include a spacer 108 with a first surface 126 and a second surface 128 opposite the first surface 126, and the first surface 126 is adjacent to the interior surface 106 of the container 102. In some examples, a capsule 110 is adjacent the second surface 128 of the spacer 108, and the capsule 110 contains PCM 122 that encapsulates a flavor product 124. In some examples, the flavor product 124 is released from the capsule 110 and directed towards the food item 104 when the PCM 122 is exposed to microwave energy to cause a phase change within the PCM 122, and a quantity of the flavor product 124 released depends on a power level and an exposure time of the microwave energy delivered to the apparatus 100 during operation. In some examples, the quantity of flavor product 124 may be in the range of about 0.1 g to 100 g of flavor product. In some examples, the first capsule 110 may release the flavor product 124 after a sufficient energy level based upon the power and duration of microwave energy that the apparatus 100 is exposed to.

The power rating of the microwave energy utilized may be of any appropriate power rating such as, for example 500W, 600 W, 700 W, 800 W, 900 W, 1000 W, 1100 W, 1200 W, 1500 W, 2000 W or 2500 W, inclusive of ranges there between. In some examples, the duration of microwave energy is at least 1 minute, 2 minutes, 3 minutes, 4 minutes, or 5 minutes, inclusive of ranges there between. In some examples, the power and time duration of the microwave energy is at least 1000 Watts and at least 2 minutes. In some examples, the edible item 104 may transfer energy to the capsule 110. Other powers and durations may be used in other examples.

In some examples, a position of the flavor product 124 within the PCM 122 may cause a staggered release of the flavor product 124 through the first aperture 112.

FIG. 1D is a cross-sectional view of the microwaveable food flavoring apparatus along line 1D-1D of FIG. 1B showing an example of a first capsule. FIG. 1D shows a microwaveable food flavoring apparatus 100 with a container 102 with an interior surface 106, an edible item 104, a microwave absorption material 118, a spacer 108 with a first surface 126 and a second surface 128, a capsule 110 with a PCM 122, an aperture 112, and a flavor product 124, microwave energy 150, conductive heat transfer 152, and convective heat transfer 154. The various components described in FIG. 1D are merely examples, and other variations, including eliminating components, combining components, adding components, and substituting components are all contemplated.

In some examples, a user may place a container 102 containing a microwave edible item 104 into a microwave to cook or heat the edible item 104. When the microwave energy 150 is generated from the microwave, the microwave energy 150 may be absorbed into the edible item 104, and a temperature of the edible item 104 may begin to increase. As the temperature of the edible item 104 increases, the heat from the edible item 104 may heat the air surrounding the edible item 104 through convective heat transfer 154. The convective heat transfer 154 from the edible item 104 may travel towards spacer 108, where it may be wholly and/or partially absorbed by the spacer 108.

When the microwave energy 150 is generated from the microwave, all or portions of the microwave energy 150 may be absorbed into the microwave absorption material 118. As the microwave absorption material 118 absorbs the microwave energy 150, the temperature of the microwave absorption material 118 will begin to increase. As the temperature of the microwave absorption material 118 increases, the heat from the microwave absorption material 118 may heat the air surrounding the microwave absorption material 118 through convective heat transfer 154. In addition, the heat from the microwave absorption material 118 may heat the spacer 108 through conductive heat transfer 152, as the first surface 126 of the spacer 108 is adjacent the microwave absorption material 118.

As the temperature of the spacer 108 begins to increase, through conductive heat transfer 152, convective heat transfer 154, or a combination of both, the temperature of the capsule 110 may increase, which may cause the heating of the PCM 122 within the capsule 110. Upon reaching the phase change temperature of the PCM 122, the PCM 122 may change phase from a solid to a liquid. In an example, when the PCM 122 surrounding the flavor product 124 changes to a liquid, the PCM 122 may separate or flow away from the flavor product 124, such that it no longer surrounds or encapsulates the flavor product 124.

In some examples, once the flavor product 124 is no longer surrounded or encapsulated by the PCM 122, it will no longer be protected from the microwave radiation 150. Upon exposure to microwave radiation 150, the flavor product 124 may change from a solid form to a liquid form to a gaseous form, or it may change from a liquid form to a gaseous form. Upon change to the gaseous form, the flavor product 124 may be vaporized. In some examples, the flavor product 124 may be released as a vaporized food product.

In some examples, once the flavor product 124 is no longer surrounded or encapsulated by the PCM 122, it may still be protected from microwave radiation based upon the construction of the pouch or capsule that the flavor product 124 is contained within. In these examples, the flavor product 124 may be heated conductively by the heat of the PCM 122.

In other examples, no changes in the state of the flavor product 124 may occur. For example, the flavor product 124 may be a solid, liquid, and/or gaseous material, and may maintain in that state during and/or after exposure to microwave radiation. Once the PCM 122 is no longer encapsulating the flavor product 124, the flavor product 124 may pass through one or more of the apertures 112, and in some cases, contact the edible item 104. In some examples, a vaporized flavor product 124 may exit the capsule 110 through the apertures 112, and in some cases, then contact the edible item 104, which would thereby affect the flavor, the aroma, or both of the edible item 104. In some examples, the vaporized flavor product 124 may affect the aroma surrounding the edible item 104 such that a user is exposed to the aroma when opening the microwave upon the finished heating of the edible item 104.

In some examples, the flavor product 124 is spicy. In some examples, the flavor product 124 may have the taste or aroma of salt; spicy in the form of curry, red pepper, buffalo sauce, salsa, chili, cayenne pepper, black pepper, or the like; sweet in the form of sugar, honey, agave, or the like; or have the general characteristic of a spice including garlic, rosemary, oregano, paprika, cilantro, coriander, cumin, sage, parsley, saffron, star anise, mustard, lemon, orange, grapefruit, or other citrus flavors, poultry seasoning, balsamic vinegar, olive oil, dill, mint, thyme, lavender, basil, bay leaf, celery seed, chives, cinnamon, cloves, dill seed, fennel, ginger, marjoram, nutmeg, poppy seeds, peppermint, sesame seed, tarragon, turmeric or the like.

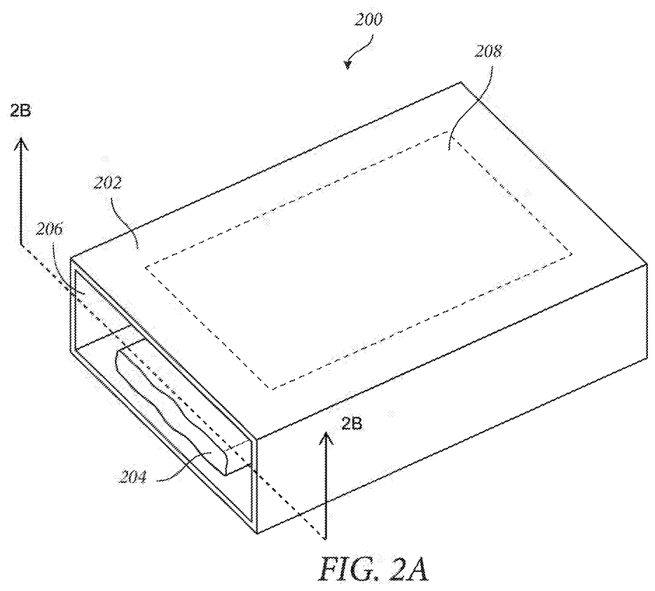

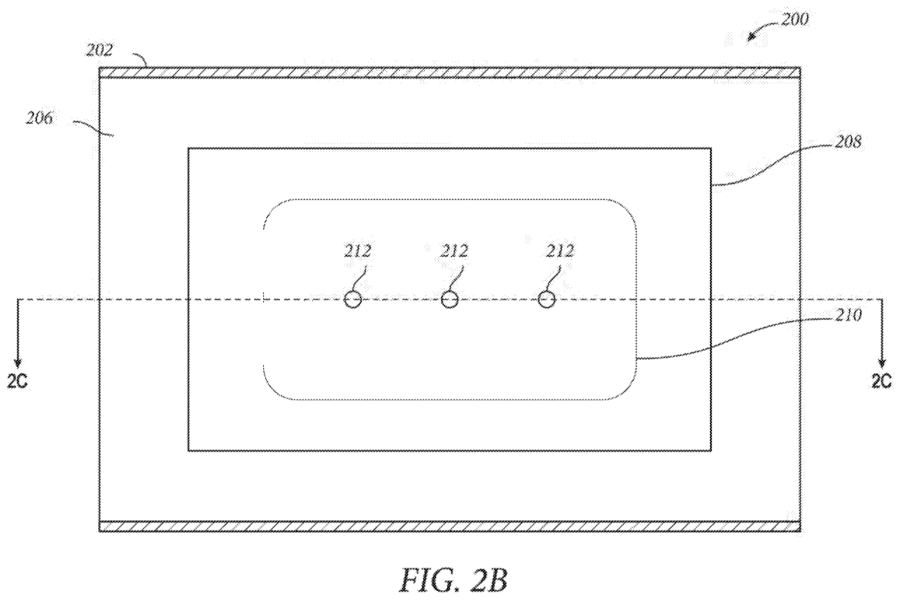

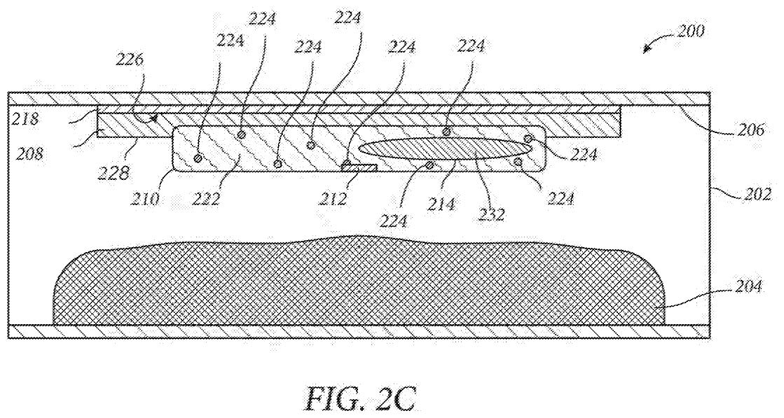

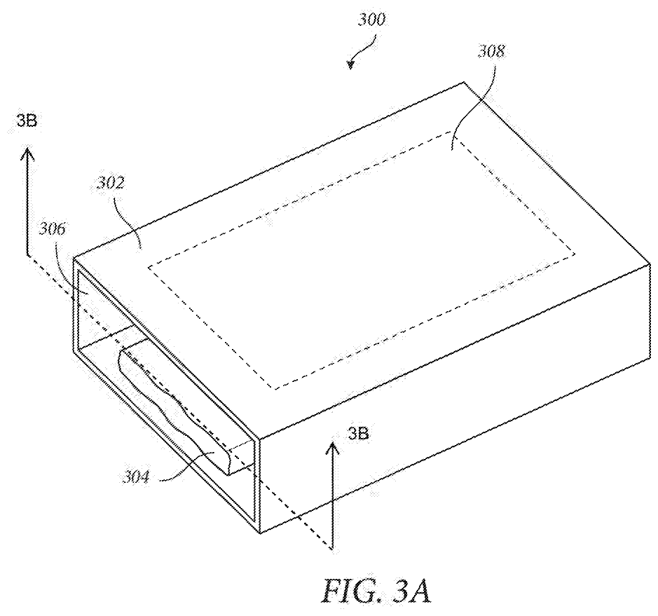

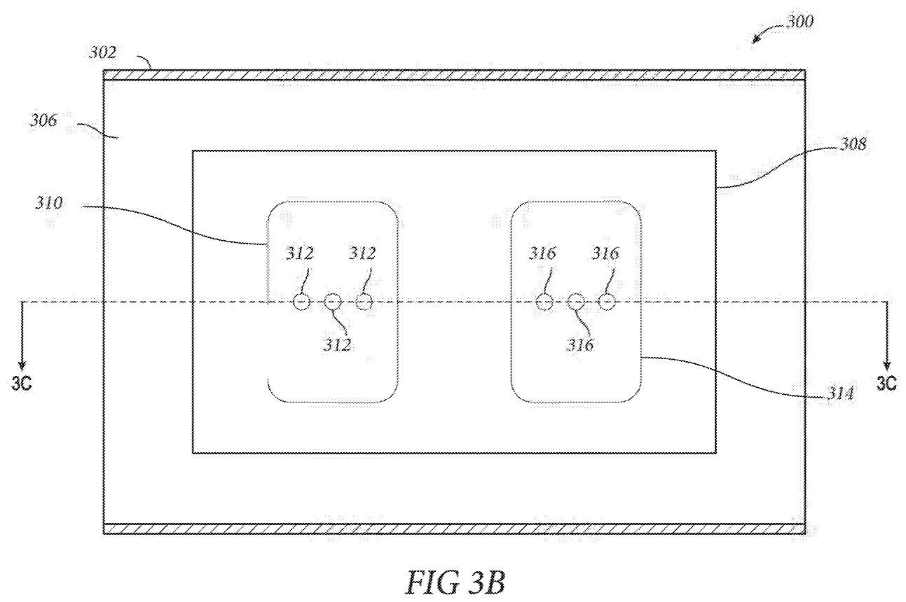

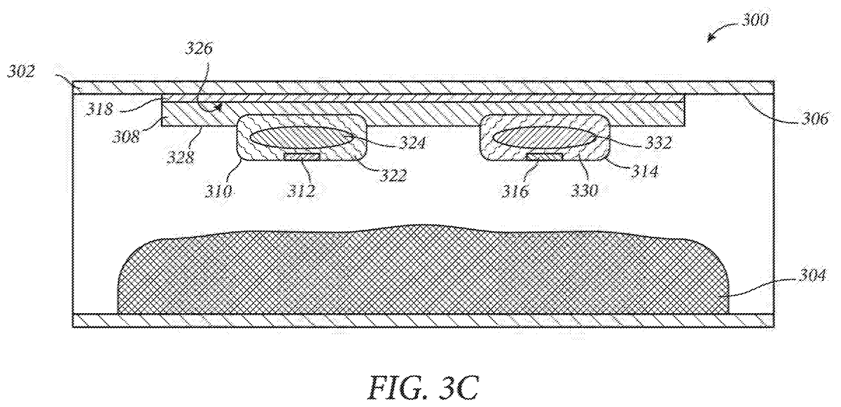

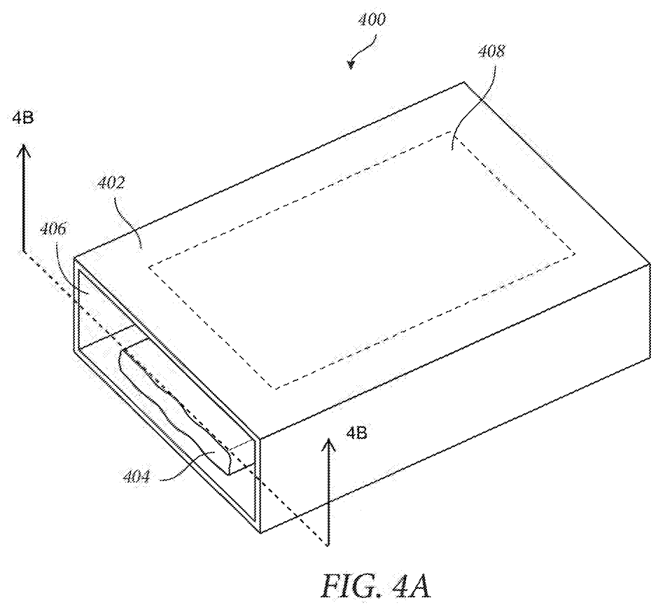

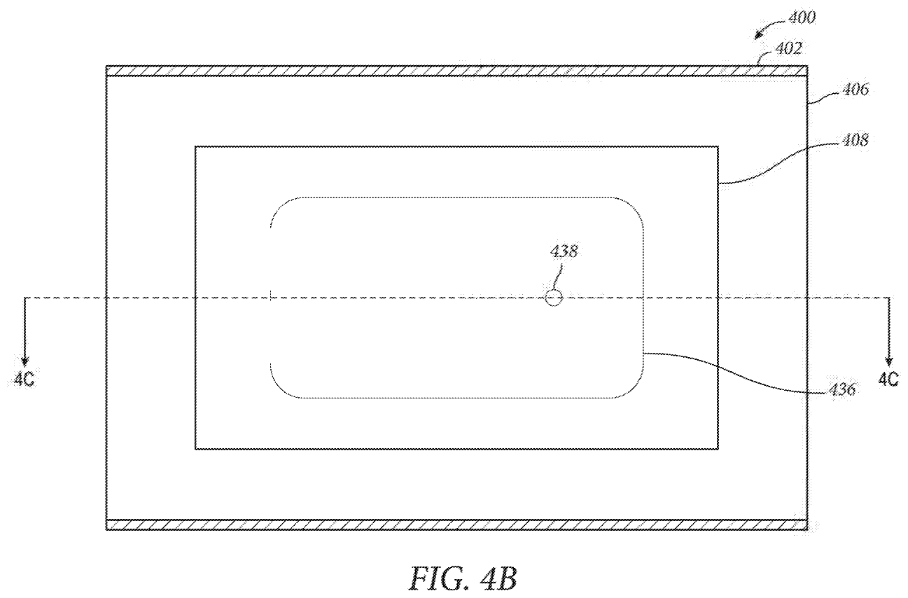

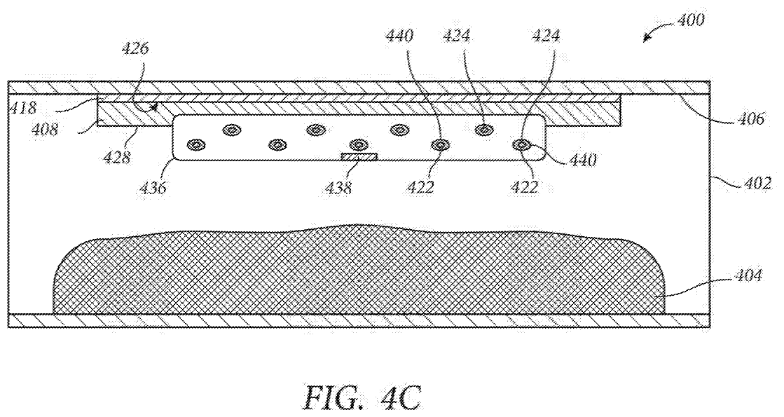

In some examples, the process of heating as described with reference to FIG., 1D is also applicable to FIGS. 2C, 3C, 4C, and SC. In some examples, the microwaveable food flavoring apparatus 100 and components of FIG. 1D may be similar to the microwaveable food flavoring apparatus 200 and components of FIG. 2C, and/or similar to the microwaveable food flavoring apparatus 300 and components of FIG. 3C, and/or similar to the microwaveable food flavoring apparatus 400 and components of FIG. 4C.

FIG. 2A is a perspective view of another example microwaveable food flavoring apparatus. FIG. 2A shows a microwaveable food flavoring apparatus 200; a container 202 with an interior surface 206; an edible item 204; and a spacer 208. The various components described in FIG. 2A are merely examples, and other variations, including eliminating components, combining components, adding components, and substituting components are all contemplated.

In some examples, a microwaveable food flavoring apparatus 200 may include a container 202 with an interior surface 206. A microwaveable edible item 204 may be located inside the container 202. A spacer 208 may also be located inside the container 202, attached to the interior surface 206 of the container 202. In some examples, the container 202 may be at least partially made from paper packaging.

In various examples, the spacer 208 may be a susceptor. In some examples, the spacer 208 may include a cardboard material, such as thin cardboard, porous cardboard, etc. In some other examples, the spacer may be made from a material with a thermal conductivity that is in a conductivity range of about 0.030 to 0.040 Watts/(meter-Kelvin). In some additional examples, the spacer may be made from a material with a thermal conductivity of about 0.037 Watts/(meter-Kelvin).

In some further examples, the container 202 may also contain a component configured to absorb microwave energy once the edible item 204 has reached a desired temperature, thereby at least partially preventing the edible item 204 from being overheated or overcooked. In various examples, the component configured to absorb microwave energy may include a phase change material.

FIG. 2B is a cross-sectional view of the microwaveable food flavoring apparatus along line 2B-2B of FIG. 2A showing another example of a spacer with a first capsule. FIG. 2B shows a microwaveable food flavoring apparatus 200 with an interior surface 206 of a container 202; a spacer 208; a first capsule 210 with apertures 212. The various components described in FIG. 2B are merely examples, and other variations, including eliminating components, combining components, adding components, and substituting components are all contemplated.

In some examples, the at least one capsule 210 may be at least partially made of a food grade microwave reflector material. The first capsule 210 may include a microwave reflector material or a material in which microwaves do not penetrate. The selection of the material for the first capsule 210 may include a material that protects a product within the first capsule 210 from exposure to microwaves formed during the operation of a microwave. This protection may prevent or reduce the unintentional heating of a product contained within the first capsule 210 when the container 202 is placed inside the microwave to heat or cook the microwaveable edible item 204. The apertures 212 of the capsule 210 may allow the release of a product stored within the capsule 210 upon the proper heating of the capsule 210 through convective or conductive heating. The spacing of the apertures 212 may prevent some or all of the microwave radiation emitted when the microwave is operated from penetrating the product contained within the first capsule 210.

In some examples, the first capsule 210 may have a smaller cross sectional area than that of the spacer 208 when attached to the interior surface 206 of the container 202. In some examples, the first capsule 210 and the spacer 208 may have similar cross sectional areas.

In some examples, the spacer 208 has a thermal resistance and capacitance such that conductive heat dissipation between the spacer 208 and the capsule 210 occurs at a prescribed rate. In some examples, the spacer 208 may absorb the microwave energy and conductively transfer the absorbed energy to the capsule 210. In some examples, the edible item 204 may absorb the microwave energy and convectively transfer the absorbed energy to the capsule 210.

FIG. 2C is a cross-sectional view of the microwaveable food flavoring apparatus along line 2C-2C of FIG. 2B showing an example of a second capsule located within a first capsule. FIG. 2C shows a microwaveable food flavoring apparatus 200 with a container 202 with an interior surface 206, an edible item 204, a microwave absorption material 218, a spacer 208 with a first surface 226 and a second surface 228, a first capsule 210 with an aperture 212, a PCM 222, a flavor product 224, and second capsule 214 with a flavor product 232. The various components described in FIG. 2C are merely examples, and other variations, including eliminating components, combining components, adding components, and substituting components are all contemplated.

In some examples, the microwaveable food flavoring apparatus 200 and associated components of FIG. 2C may be similar to the microwaveable food flavoring apparatus 300 and associated components of FIG. 3C, and/or may be similar to the microwaveable food flavoring apparatus 100 and associated components of FIG. 1C. In other examples, the at least one capsule 210 may have a second flavor product 232 encapsulated in the PCM 222 within the capsule 210, and the second flavor product 232 is released from the capsule 210 through the at least one aperture 212 and directed towards the edible item 204 when sufficient microwave energy is transferred to the PCM 222, and the second flavor product 232 is released after the first flavor product 224 is released. In some examples, a position of the second flavor product 232 within the PCM 222 causes a staggered release of the second flavor product 232 through the first aperture 212.

In some examples, an apparatus 200 for flavoring food in a microwave has a container 202 housing at least one edible item 204, at least one spacer 208 with a first surface 226 and a second surface 228 opposite the first surface 226, the first surface 226 adjacent to an interior surface 206 of the container 202, and a first and a second capsule 210, 214. In some examples, the first capsule 210 is adjacent the second surface 228 of the spacer 208, and the first capsule 210 has at least one aperture 212, a phase change material 222 and a first flavor product 224. In some examples, the second capsule 214 has a second flavor product 232 encapsulated in the phase change material 222 within the first capsule 210, and the first flavor product 224 and the second flavor product 232 are configured to be released from the first capsule 210 and the second capsule 214 and directed towards the edible item 204 through the at least one aperture 212 when sufficient microwave energy is transferred to the phase change material 222. In some examples, the first flavor product 224 is configured to be released prior to the release of the second flavor product 232.

In some examples, the flavor product 224, 232 may be released as a vaporized food product.

In some examples, the quantity of the flavor product 224 is similar to that of the flavor product 232. In some examples, the apparatus 200 has a larger quantity of flavor product 224 than of flavor product 232. In some examples, the apparatus 200 has a larger quantity of flavor product 232 than of flavor product 224. In an example, the flavor products 224 may be made from a combination of various aromas, spices, or flavorings. In some examples, the flavor product 232 may be similar to that of the flavor product 224.

In some examples, the flavor products 224 and its similar components, and 232 and its similar components are spicy. In some examples, the flavor product 232 is different than that of the flavor product 224. In some examples, the flavor product 224 is spicy and the flavor product 232 is sweet. In some examples, the flavor products 224, 232 may have the taste or aroma of salt; spicy in the form of curry, red pepper, buffalo sauce, salsa, chili, cayenne pepper, black pepper, or the like; sweet in the form of sugar, honey, agave, or the like; or have the general characteristic of a spice including garlic, rosemary, oregano, paprika, cilantro, coriander, cumin, sage, parsley, saffron, star anise, mustard, lemon, orange, grapefruit, or other citrus flavors, poultry seasoning, balsamic vinegar, olive oil, dill, mint, thyme, lavender, basil, bay leaf, celery seed, chives, cinnamon, cloves, dill seed, fennel, ginger, marjoram, nutmeg, poppy seeds, peppermint, sesame seed, tarragon, turmeric or the like.

FIG. 3A is a perspective view of another example microwaveable food flavoring apparatus. FIG. 3A shows a microwaveable food flavoring apparatus 300; a container 302 with an interior surface 306; an edible item 304; and a spacer 308. The various components described in FIG. 3A are merely examples, and other variations, including eliminating components, combining components, adding components, and substituting components are all contemplated.

In some examples, a microwaveable food flavoring apparatus 300 may include a container 302 with an interior surface 306. A microwaveable edible item 304 may be located inside the container 302. A spacer 308 may also be located inside the container 302, attached to the interior surface 306 of the container 302. In some examples, the container 302 may be at least partially made from paper packaging.

In various examples, the spacer 308 may be a susceptor. In some examples, the spacer 308 may include a cardboard material, such as thin cardboard, porous cardboard, etc. In some other examples, the spacer may be made from a material with a thermal conductivity that is in a conductivity range of about 0.030 to 0.040 Watts/(meter-Kelvin). In some additional examples, the spacer may be made from a material with a thermal conductivity of about 0.037 Watts/(meter-Kelvin).

In some further examples, the container 302 may also contain a component configured to absorb microwave energy once the edible item 304 has reached a desired temperature, thereby at least partially preventing the edible item 304 from being overheated or overcooked. In various examples, the component configured to absorb microwave energy may include a phase change material.

FIG. 3B is a cross-sectional view of the microwaveable food flavoring apparatus along line 3B-3B of FIG. 3A showing an example of a spacer with a first capsule and a second capsule. FIG. 3B shows a microwaveable food flavoring apparatus 300 with an interior surface 306 of a container 302; a spacer 308; a first capsule 310 with apertures 312; and a second capsule 114b with apertures 316. The various components described in FIG. 3B are merely examples, and other variations, including eliminating components, combining components, adding components, and substituting components are all contemplated.

In some examples, the microwaveable food flavoring apparatus 300, interior surface 306 of container 302, spacer 308, and first capsule 310 with apertures 312 may be similar in material and construction to microwaveable food flavoring apparatus 100, interior surface 106 of container 102, spacer 108, and first capsule 110 with apertures 112 of FIGS. 1A-1C. In some examples, a second capsule 314 may be made from a material similar to that of the first capsule 310. The selection of the material for the second capsule 314 may include a material that protects a product within the second capsule 314 from exposure to microwaves formed during the operation of a microwave, thereby preventing or reducing the unintentional heating of a product contained within the second capsule 314 when the container 302 is placed inside the microwave to heat or cook the microwaveable edible item 304.

In some examples, the spacing of the apertures 316 of the second capsule 314 may allow the release of a product stored within the capsule 114b upon the proper heating of the capsule 314 through convective or conductive heating. The spacing of the apertures 316 may prevent some or all of the microwaves emitted from the microwave when operated from penetrating the product within the second capsule 314.

In some examples, the first capsule 310 and the second capsule 314 may be similarly sized. In some examples, the first capsule 310 and the second capsule 314 may have different sizes. In some examples, the first capsule 310 and the second capsule 314 may be separated from each other or located adjacent opposite ends of the spacer 308. In some examples, the first capsule 310 and the second capsule 314 may be adjacent each other.

FIG. 3C is a cross-sectional view of the microwaveable food flavoring apparatus along line 3C-3C of FIG. 3B showing an example of a spacer with a first capsule and a second capsule. FIG. 3C shows a microwaveable food flavoring apparatus 300 with a container 302 with an interior surface 306, an edible item 304, a microwave absorption material 318, a spacer 308 with a first surface 326 and a second surface 328, a first capsule 310 with an aperture 312, a PCM 322, a flavor product 324, a second capsule 114b with an aperture 316, a phase change material 330, and a flavor product 332. The various components described in FIG. 3C are merely examples, and other variations, including eliminating components, combining components, adding components, and substituting components are all contemplated.

In some examples, the microwaveable food flavoring apparatus 300 and its associated components shown in FIG. 3C may be similar to the microwaveable food flavoring apparatus 100 and its associated components of FIG. 1C, and/or similar to the microwaveable food flavoring apparatus 200 and its associated components of FIG. 2C. In other examples, the microwaveable food flavoring apparatus 300 may also have the second capsule 114b adjacent the second surface 328 of the spacer 308. In some examples, the second capsule 114b may contain a phase change material (PCM) 330 and at least a flavor product 332. The PCM 330 may absorb convective and conductive heat directed towards the second capsule 114b and thereby transferred to the PCM 330. In some examples, the PCM 330 is similar to that of the PCM 322. In some examples, the PCM 330 is dissimilar to that of PCM 322 in that the PCM 330 has a phase change or melting temperature that is different than that of PCM 322.

In some examples, the container 300 has a second phase change material 330 configured to absorb microwave energy once the edible food product 304 has reached a desired cooked temperature. In some examples, the second capsule 314 may release the second flavor product 332 after exposure to the same power of microwave energy that causes the release of the first flavor product 324.

In some examples, the flavor product 324, 332 may be released as a vaporized food product.

In some examples, the flavor product 332 may be similar to that of the flavor product 324. In some examples, the flavor products 324 and its similar components, and 332 and its similar components are spicy. In some examples, the flavor product 332 is different than that of the flavor product 324. In some examples, the flavor product 324 is spicy and the flavor product 332 is sweet. In some examples, the flavor products 324, 332 may have the taste or aroma of salt; spicy in the form of curry, red pepper, buffalo sauce, salsa, chili, cayenne pepper, black pepper, or the like; sweet in the form of sugar, honey, agave, or the like; or have the general characteristic of a spice including garlic, rosemary, oregano, paprika, cilantro, coriander, cumin, sage, parsley, saffron, star anise, mustard, lemon, orange, grapefruit, or other citrus flavors, poultry seasoning, balsamic vinegar, olive oil, dill, mint, thyme, lavender, basil, bay leaf, celery seed, chives, cinnamon, cloves, dill seed, fennel, ginger, marjoram, nutmeg, poppy seeds, peppermint, sesame seed, tarragon, turmeric or the like.

FIG. 4A is a perspective view of another example microwaveable food flavoring apparatus. FIG. 4A shows a microwaveable food flavoring apparatus 400; a container 402 with an interior surface 406; an edible item 404; and a spacer 408. The various components described in FIG. 4A are merely examples, and other variations, including eliminating components, combining components, adding components, and substituting components are all contemplated.

In some examples, a microwaveable food flavoring apparatus 400 may include a container 402 with an interior surface 406. A microwaveable edible item 404 may be located inside the container 402. A spacer 408 may also be located inside the container 402, attached to the interior surface 406 of the container 402. In some examples, the container 402 may be at least partially made from paper packaging.

In various examples, the spacer 408 may be a susceptor. In some examples, the spacer 408 may include a cardboard material, such as thin cardboard, porous cardboard, etc. In some other examples, the spacer 408 may be made from a material with a thermal conductivity that is in a conductivity range of about 0.030 to 0.040 Watts/(meter-Kelvin). In some additional examples, the spacer may be made from a material with a thermal conductivity of about 0.037 Watts/(meter-Kelvin).

In some further examples, the container 402 may also contain a component configured to absorb microwave energy once the edible item 404 has reached a desired temperature, thereby at least partially preventing the edible item 404 from being overheated or overcooked. In various examples, the component configured to absorb microwave energy may include a phase change material.

FIG. 4B is a cross-sectional view the example microwaveable food flavoring apparatus along line 4B-4B of FIG. 4A showing an example of a spacer with a pouch. FIG. 4B shows a microwaveable food flavoring apparatus 400 with an interior surface 406 of a container 402; a spacer 408; a pouch 436 with an aperture 438. The various components described in FIG. 4B are merely examples, and other variations, including eliminating components, combining components, adding components, and substituting components are all contemplated.

In some examples, the microwaveable food flavoring apparatus 400 and its associated components may be similar to the microwaveable food flavoring apparatus 100 and its associated components shown in FIGS. 1A-1D, and/or the microwaveable food flavoring apparatus 200 and its associated components shown in FIG. 2A-2C, and/or the microwaveable food flavoring apparatus 300 and its associated components shown in FIG. 3A-3C. In other examples, a pouch 436 with an aperture 438 may be used instead of capsules 110, 310 with apertures 112, 312 as shown in FIGS. 1B and 3B. In some examples, the pouch 436 may be made from a microwave reflector material similar to the material used for capsules 110 or 310.

FIG. 4C is a cross-sectional view of the microwaveable food flavoring apparatus along line 4C-4C of FIG. 4B showing an example of a pouch containing multiple first capsules. FIG. 4C shows a microwaveable food flavoring apparatus 400 with a container 402 with an interior surface 406, an edible item 404, a microwave absorption material 418, a spacer 408 with a first surface 426 and a second surface 428, a pouch 436 with an opening 438, a PCM 422, capsules 440, and a flavor product 424. The various components described in FIG. 4C are merely examples, and other variations, including eliminating components, combining components, adding components, and substituting components are all contemplated.

In some examples, the microwaveable food flavoring apparatus 400 and components of FIG. 4C may be similar to the microwaveable food flavoring apparatus 100 and components of FIGS. 1A-1D, and/or the microwaveable food flavoring apparatus 200 and components of FIG. 2A-2C, and/or the microwaveable food flavoring apparatus 300 and components of FIG. 3A-3C. In other examples, the pouch 436 may be adjacent to the second surface 428 of the spacer 408. In some examples, the pouch 436 may be made from a microwave reflector material, similar to that of the first capsule 110c or the second capsule 114c. In other examples, the pouch 436 may contain multiple capsules 440, with each capsule being individually encapsulated or coated by the PCM 422. In some examples, microwave radiation cannot penetrate into the pouch 436 to heat the PCM 422 or the capsules 440. The heating of the PCM 422 may be facilitated through the pouch 436 by conduction of heat between the spacer 408 and the pouch 436. This apparatus and method may enable and/or assist a user to accurately control the heating rate and temperature of the flavor product 424 in the capsules 440.

In some examples, the flavor product 424 may be released as a vaporized food product.

In some examples, the flavor product 424 is spicy. In some examples, the flavor product 424 is sweet. In some examples, the flavor product 424 may have the taste or aroma of salt; spicy in the form of curry, red pepper, buffalo sauce, salsa, chili, cayenne pepper, black pepper, or the like; sweet in the form of sugar, honey, agave, or the like; or have the general characteristic of a spice including garlic, rosemary, oregano, paprika, cilantro, coriander, cumin, sage, parsley, saffron, star anise, mustard, lemon, orange, grapefruit, or other citrus flavors, poultry seasoning, balsamic vinegar, olive oil, dill, mint, thyme, lavender, basil, bay leaf, celery seed, chives, cinnamon, cloves, dill seed, fennel, ginger, marjoram, nutmeg, poppy seeds, peppermint, sesame seed, tarragon, turmeric or the like.

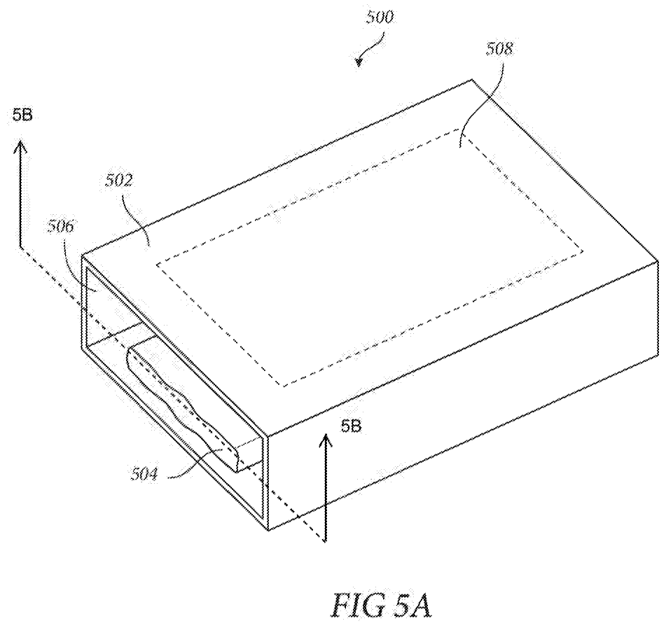

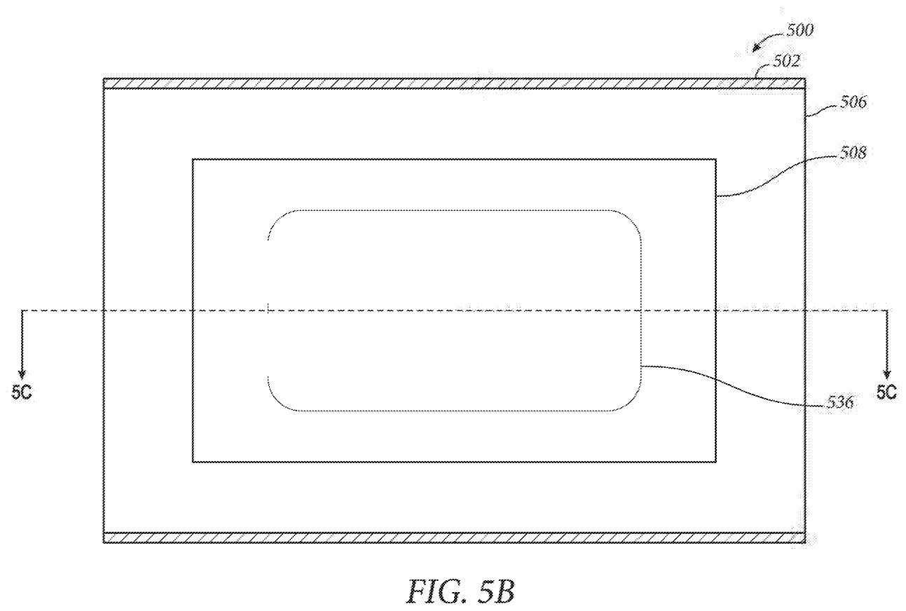

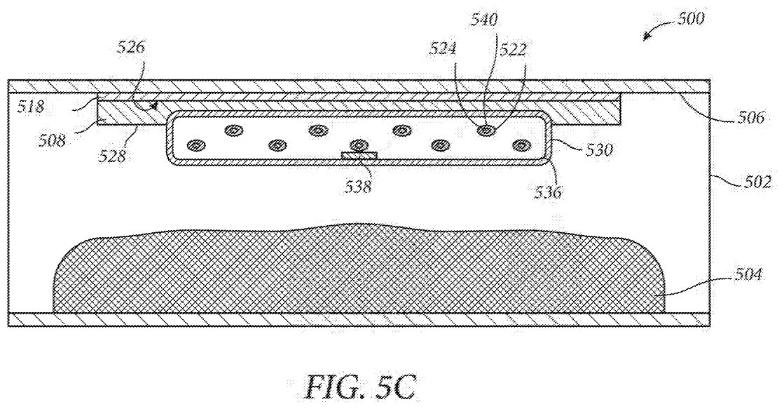

FIG. 5A is a perspective view of another example microwaveable food flavoring apparatus. FIG. 5A shows a microwaveable food flavoring apparatus 500; a container 502 with an interior surface 506; an edible item 504; and a spacer 508. The various components described in FIG. 5A are merely examples, and other variations, including eliminating components, combining components, adding components, and substituting components are all contemplated.

In some examples, a microwaveable food flavoring apparatus 500 may include a container 502 with an interior surface 506. A microwaveable edible item 504 may be located inside the container 502. A spacer 508 may also be located inside the container 502, attached to the interior surface 506 of the container 502. In some examples, the container 502 may be at least partially made from paper packaging.

In various examples, the spacer 508 may be a susceptor. In some examples, the spacer 508 may include a cardboard material, such as thin cardboard, porous cardboard, etc. In some other examples, the spacer 508 may be made from a material with a thermal conductivity that is in a conductivity range of about 0.030 to 0.040 Watts/(meter-Kelvin). In some additional examples, the spacer may be made from a material with a thermal conductivity of about 0.037 Watts/(meter-Kelvin).

In some further examples, the container 502 may also contain a component configured to absorb microwave energy once the edible item 504 has reached a desired temperature, thereby at least partially preventing the edible item 504 from being overheated or overcooked. In various examples, the component configured to absorb microwave energy may include a phase change material.

FIG. 5B is a cross-sectional view the microwaveable food flavoring apparatus along line 5B-5B of FIG. 5A showing another example of a spacer with a pouch. FIG. 5B shows a microwaveable food flavoring apparatus 500 with an interior surface 506 of a container 502; a spacer 508; a pouch 536 with an aperture 538. The various components described in FIG. 5B are merely examples, and other variations, including eliminating components, combining components, adding components, and substituting components are all contemplated.

In some examples, the microwaveable food flavoring apparatus 500 and its associated components may be similar to the microwaveable food flavoring apparatus 100 and its associated components shown in FIGS. 1A-1C, or the microwaveable food flavoring apparatus 200 and its associated components shown in FIGS. 2A-2C, or the microwaveable food flavoring apparatus 400 and its associated components shown in FIGS. 4A-4C. In other examples, a pouch 536 with an aperture 538 may be used instead of capsules 110, 210 with apertures 112, 212 as shown in FIGS. 1B and 2B. In some examples, the pouch 536 may be made from a microwave reflector material similar to the material used for capsules 110 or 210.

FIG. 5C is a cross-sectional view the microwaveable food flavoring apparatus along line 5C-5C of FIG. 5B showing another example of a pouch containing multiple first capsules. FIG. 5C shows a microwaveable food flavoring apparatus 500 with a container 502 with an interior surface 506, an edible item 504, a microwave absorption material 518, a spacer 508 with a first surface 526 and a second surface 528, a pouch 536 with an aperture 538, a PCM 522, a PCM 530, capsules 540, and a flavor product 524. The various components described in FIG. 5C are merely examples, and other variations, including eliminating components, combining components, adding components, and substituting components are all contemplated.

In some examples, the microwaveable food flavoring apparatus 500 and components of FIG. 5C may be similar to the microwaveable food flavoring apparatus 500 and components 400 of FIG. 4C. In other examples, FIG. 5C may also have a PCM 530 coating an exterior of the pouch 536. In some examples, the PCM 530 may add an additional barrier that may increase the delayed release of flavor product 524.

In some examples, the flavor product 524 may be released as a vaporized food product.

In some examples, the flavor product 524 is spicy. In some examples, the flavor product 524 is sweet. In some examples, the flavor product 524 may have the taste or aroma of salt; spicy in the form of curry, red pepper, buffalo sauce, salsa, chili, cayenne pepper, black pepper, or the like; sweet in the form of sugar, honey, agave, or the like; or have the general characteristic of a spice including garlic, rosemary, oregano, paprika, cilantro, coriander, cumin, sage, parsley, saffron, star anise, mustard, lemon, orange, grapefruit, or other citrus flavors, poultry seasoning, balsamic vinegar, olive oil, dill, mint, thyme, lavender, basil, bay leaf, celery seed, chives, cinnamon, cloves, dill seed, fennel, ginger, marjoram, nutmeg, poppy seeds, peppermint, sesame seed, tarragon, turmeric or the like.

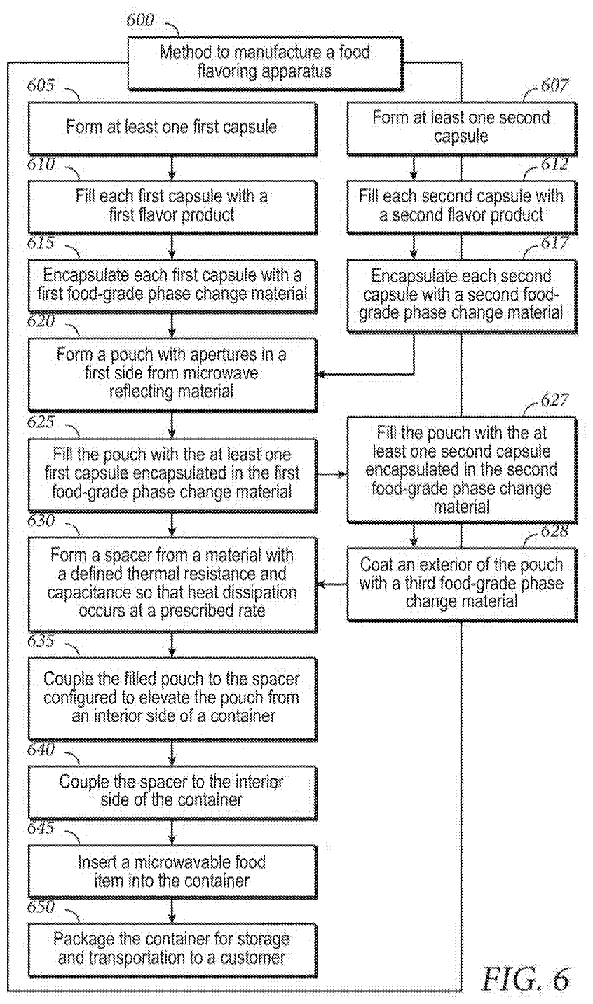

FIG. 6 is a flow chart describing an example method to manufacture a food flavoring apparatus. FIG. 6 shows a method which states “method to manufacture a food flavoring apparatus” in block 600; block 605 which states “form at least one first capsule;” block 607 which states “form at least one second capsule;” block 610 which states “fill each first capsule with a first flavor product;” block 612 which states “fill each second capsule with a second flavor product;” block 615 which states “encapsulate each first capsule with a first food-grade phase change material;” block 617 which states “encapsulate each second capsule with a second food-grade phase change material;” block 620 which states “form a pouch with apertures in a first side from microwave reflector material;” block 625 which states “fill the pouch with the at least one first capsule encapsulated in the first food-grade phase change material;” block 627 which states “fill the pouch with the at least one second capsule encapsulated in the second food-grade phase change material;” block 628 which states “coat an exterior of the pouch with a third food-grade phase change material;” block 630 which states “form a spacer from a material with a defined thermal resistance and capacitance so that heat dissipation occurs at a prescribed rate;” block 635 which states “couple the filled pouch to a spacer configured to elevate the pouch from an interior side of a container,” block 640 which states “couple the spacer to the interior side of the container;” block 645 which states “insert a microwavable food item into the container;” and block 650 which states “package the container for storage and transportation to a customer.” The various blocks described in FIG. 6 are merely examples, and other variations, including eliminating blocks, combining blocks, modifying blocks, supplementing with additional blocks, and substituting blocks are all contemplated. Moreover, the various operations need not necessarily occur in the exact order that is shown.

FIG. 6 shows a method 600 to manufacture a food flavoring apparatus. The method 600 may include forming at least one first capsule in block 605. In some examples, the first capsule may correspond to element 110 shown in, at a minimum, FIG. 1B. The first capsule may be made from a variety of materials. In an example, the first capsule may be made from a material that reflects microwaves or prevents them from penetrating the capsule. In an example, the first capsule may be made from an edible material capable of constraining a volatile material housed within the capsule.

The method 600 may include filling each first capsule with a first flavor product in block 610. In some examples, the first flavor product may correspond to flavor products 124, 224, 324, 424, or 524 shown in, at a minimum, FIG. 1C, 2C, 3C, 4C, or 5C. In some examples, the first flavor product may be a volatile material. In some examples, the flavor product may be in liquid or solid form when the first capsule is filled. In some examples, the first flavor product may be made up a food grade material having multiple flavor profiles, such as sweet and spicy, sweet and savory, salty and savory, etc.

The method 600 may include encapsulating or coating each first capsule with a first food-grade phase change material in block 615. In an example, the first food grade phase change material may be similar to PCM 122, 222, 322, 422, or 522 shown, at a minimum, in FIG. 1C, 2C, 3C, 4C, or 5C. In some examples, the first food grade phase change material may be processed fats or oils, such as those that are vegetable based. In some examples, the first food grade phase change material may be capable of microencapsulation.

The method 600 may include forming a pouch with apertures in a first side from microwave reflector material in block 620. In some examples, the pouch may be similar to the pouch 436 shown, at a minimum, in FIG. 4C. In an example, the pouch may also be formed with apertures in a first side.

The method 600 may include filling the pouch with the at least one first capsule encapsulated or coated in the first food-grade phase change material in block 625. In some examples, the at least one first capsule coated in the first food-grade phase change material may be similar to the capsules 440, 540 coated with PCM 422, 522 shown in, at a minimum, FIG. 4C or 5C.

The method 600 may include forming a spacer from a material with a defined thermal resistance and capacitance so that heat dissipation occurs at a prescribed rate in block 630. In some examples, the spacer may be similar to the spacer 108, 208, 308, 408, or 508 shown in, at a minimum, FIG. 1B, 2B, 3B, 4B or 5B. In some examples, the spacer may be used to elevate an item away from an interior surface of a container.

The method 600 may include coupling the filled pouch to the spacer configured to elevate the pouch from an interior side of a container in block 635. The method 600 may include coupling the spacer to the interior side of the container in block 640. In some examples, a surface of the spacer may be coupled to an interior side of the container opposite the spacer surface the pouch is coupled to. In some examples, the location of the spacer and the affixed pouch may be opposite an area where a microwavable food item may be placed, so that the spacer and pouch are elevated above the microwavable food item.

The method 600 may include inserting a microwavable food item into the container in block 645. In some examples, the microwavable food item may be similar to the microwavable edible item 104, 204, 304, 404, or 504 shown in, at a minimum, FIG. 1A, 2A, 3A, 4A, or 5A. In an example, the microwavable food item may be frozen or thawed. Any of a variety of microwaveable food items may be used in examples described herein including, but not limited to, beverages, meat, poultry, fries, popcorn, soup, snacks, eggrolls, pockets, or combinations thereof. The method 600 may also include packaging the container for storage and transportation to a customer in block 650.

Accordingly, in some examples, a method of creating a food item may include forming at least one first capsule, filling each first capsule with a first flavor product, coating each first capsule with a first food-grade phase change material, filling a pouch with apertures in a first side with the at least one first capsule coated in the first food-grade phase change material, coupling the filled pouch to a spacer configured to elevate the pouch from an interior surface of a container, coupling the pouch to the interior surface of the container, and inserting a microwavable food item into the container. In some examples, the method may also include packaging the container for storage and transportation to a customer.

The method 600 may also include utilizing a second capsule. In examples utilizing a second capsule, at least one second capsule may be formed in block 607. The second capsule may be similar to that of the second capsule 214 or 314 shown in, at a minimum, FIG. 2C or 3C. The second capsule may be similar to the first capsule of block 605.

If utilizing a second capsule, the method 600 may also include filling each second capsule with a second flavor product as in block 612. In some examples, the second flavor product may be similar to the flavor product 232, 332 shown in, at a minimum, FIGS. 2C and 3C. In some examples, the second flavor product may be similar to the first flavor product of block 610. In some examples, the second flavor product may be different than the first flavor product of block 610.

If utilizing a second capsule, the method 600 may also include encapsulating or coating each second capsule with a second food-grade phase change material in block 617. In some examples, the second food-grade phase change material may be similar to the PCM 330 or 530 shown in, at a minimum, FIG. 3C or 5C. In some examples, the second food-grade phase change material may be similar to that of the first food-grade phase change material of block 615. In some examples, the second food-grade phase change material may be different than that of the first food-grade phase change material of block 615.

If utilizing a second capsule, the method 600 may also include filling the pouch with the at least one second capsule encapsulated in the second food-grade phase change material in block 627.

In some examples, the method may also include forming at least one second capsule; filling each second capsule with a second flavor product, coating each second capsule with the second food-grade phase change material, and filling a pouch with apertures in a first side with the at least one second capsule coated in the second food-grade phase change material.

Method 600 may also include coating an exterior of the pouch with a third food-grade phase change material in block 628. In some examples, the third phase change material may be similar to or different than that of the second food-grade phase change material of block 617. In some examples, the third phase change material may be similar to or different than that of the first food-grade phase change material of block 615.

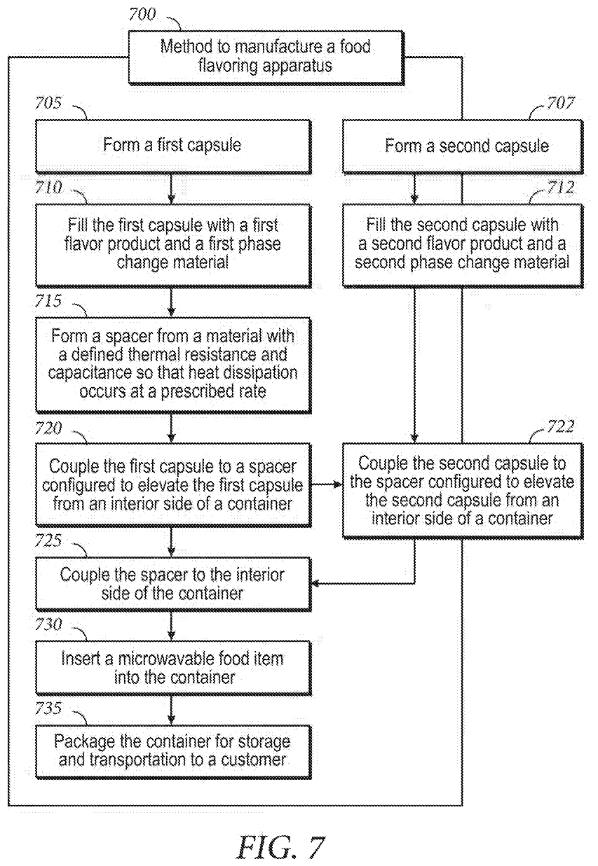

FIG. 7 is a flow chart describing an example method to manufacture a food flavoring apparatus. FIG. 7 shows a block 700 which states “method to manufacture a food flavoring apparatus;” block 705 which states “form a first capsule;” block 707 which states “form a second capsule;” block 710 which states “fill the first capsule with a first flavor product and a first phase change material;” block 712 which states “fill the second capsule with a second flavor product and a second phase change material;” block 715 which states “form a spacer from a material with a defined thermal resistance and capacitance so that heat dissipation occurs at a prescribed rate;” block 720 which states “couple the first capsule to a spacer configured to elevate the first capsule from an interior side of a container;” block 722 which states “couple the second capsule to the spacer configured to elevate the second capsule from an interior side of a container block 725 which states “couple the spacer to the interior side of the container;” block 730 which states “insert a microwavable food item into the container;” and block 735 which states “package the container for storage and transportation to a customer.” The various blocks described in FIG. 7 are merely examples, and other variations, including eliminating blocks, combining blocks, modifying blocks, supplementing with additional blocks, and substituting blocks are all contemplated. Moreover, the various operations need not necessarily occur in the exact order that is shown.

The steps of block 700 may use similar materials and processes to those steps described in block 600 of FIG. 6. In an example, block 700 may differ from block 600 in that there is not a pouch. Block 700 may differ from block 600 by way of block 710, which includes the step of filling the first capsule with a first flavor product and a first phase change material. In some examples, the first capsule, first flavor product, and phase change material may be similar to that of the capsule 110, 210, or 310, the flavor product 124, 224, or 324, and PCM 122, 222, or 322, shown in, at a minimum, FIG. 1C, 2C, or 3C. Block 720 may include coupling the first capsule to a spacer configured to elevate the capsule from an interior side of a food package. In some examples, the spacer is located on an interior side opposite an interior side where a microwaveable food item may be placed.

In addition, block 700 may also include a second capsule. In some examples, block 700 may include filling the second capsule with a second flavor product and a second phase change material in block 612, and coupling the second capsule to the spacer configured to elevate the capsule from an interior side of a food package in block 722. The second capsule, second flavor product, and second phase change material may be similar to that of the second capsule 314, second flavor product 332, and PCM 330 shown in, at a minimum, FIG. 3C. While two capsules are described with reference to some examples herein, including with reference to FIG. 7, in other examples, any number of capsules may be provided including 1, 2, 3, 4, 5, 6, 7, 8, 9, 10, 15, 20, 25, 30, 35, 40, 45, 50, or more capsules or any range there between.

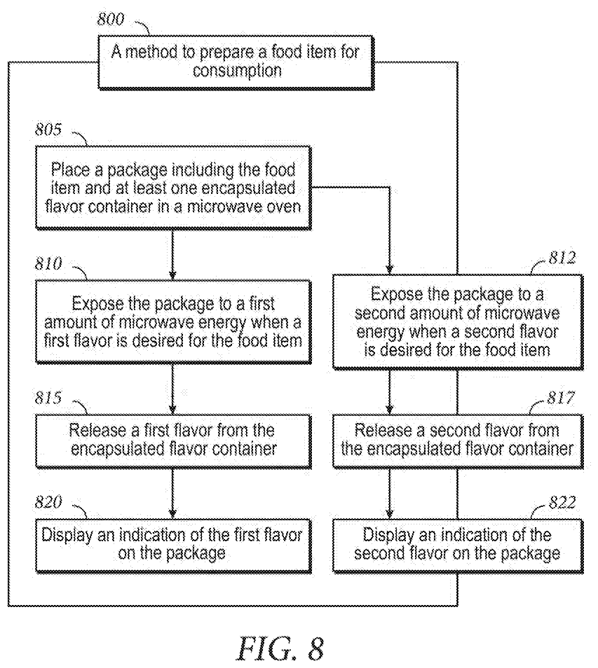

FIG. 8 is a flow chart describing an example method to prepare a food item for consumption. FIG. 8 shows a method which states “a method to prepare a food item for consumption” in block 800; block 805 which states “place a package including the food item and at least one encapsulated flavor container in a microwave oven;” block 810 which states “expose the package to a first amount of microwave energy when a first flavor is desired for the food item;” block 812 which states “expose the package to a second amount of microwave energy when a second flavor is desired for the food item;” block 815 which states “release a first flavor from the encapsulated flavor container;” block 817 which states “release a second flavor from the encapsulated flavor container,” block 820 which states “display an indication of the first flavor on the package;” and block 822 which states “display an indication of the second flavor on the package.” The various blocks described in FIG. 8 are merely examples, and other variations, including eliminating blocks, combining blocks, modifying blocks, supplementing with additional blocks, and substituting blocks are all contemplated. Moreover, the various operations need not necessarily occur in the exact order that is shown.

The method 800 discloses preparing a food item for consumption. In some examples, the method 800 may include placing a package including the food item and at least one encapsulated flavor container in a microwave oven in block 805. In some examples, an encapsulated flavor container may be a capsule, similar to capsule 110, 210, or 310 and/or capsule 214, or 314 shown in, at a minimum, FIG. 1C, 2C or 3C. In some examples, an encapsulated flavor container may be a pouch, similar to pouch 436 or 536, shown in, at a minimum, FIG. 4C or 5C. In some examples, the method 800 may also include exposing the package to a first amount of microwave energy when a first flavor is desired for the food item in block 810. In an example, block 810's exposing step may include a first amount of microwave energy in a range of about 500 Watts to about 2500 Watts for a duration in between a range of about 1 minute to about 10 minutes. In an example, exposing in block 810 may include a first amount of microwave energy of about 1000 watts for a duration of about 2 minutes.

The method 800 may include releasing a first flavor from the encapsulated flavor container in block 815. In some examples, the first flavor may be similar to flavor product 124, 224, 324, 424, or 524 shown in, at a minimum, FIG. 1C, 2C, 3C, 4C, or 5C. In an example, the first flavor may have the taste or aroma of salt, spicy in the form of curry, red pepper, buffalo sauce, salsa, chili, cayenne pepper, black pepper, or the like; sweet in the form of sugar, honey, agave, or the like; or have the general characteristic of a spice including garlic, rosemary, oregano, paprika, cilantro, coriander, cumin, sage, parsley, saffron, star anise, mustard, lemon, orange, grapefruit, or other citrus flavors, poultry seasoning, balsamic vinegar, olive oil, dill, mint, thyme, lavender, basil, bay leaf, celery seed, chives, cinnamon, closed, dill seed, fennel, ginger, marjoram, nutmeg, poppy seeds, peppermint, sesame seed, tarragon, turmeric or the like.

The method 800 may include displaying an indication of the first flavor on the package in block 820. In some examples, the package may be configured to change color or have an image appear after the package has been exposed to a first amount of microwave energy and/or that the first flavor has been released. This first amount of microwave energy may be similar to the microwave energy and duration described with respect to block 810. The indication display may be a desirable feature so that a user may understand how the flavor profile of the food item has been altered. In an example, the package may be configured to display an outline of a chili pepper to indicate a spicy flavor component has been added. In some examples, a portion of the package may be configured to display a color (e.g., red) to indicate a spicy flavor component has been added. In some examples, the package may change to display an image (e.g., an outline of a honeypot) to indicate a flavor (e.g., sweet) has been released.

The method 800 may also include releasing a second flavor. In an example, this method 800 may include exposing the package to a second amount of microwave energy when a second flavor is desired for the food item in block 812. In some examples, the second amount of microwave energy may be similar to that of the amount described in relation to block 815. In an example, the second amount of microwave energy may be different than the first amount of microwave energy of block 810. The method 800 may also include releasing a second flavor from the encapsulated flavor container in block 817. In some examples, the second flavor may be similar to that of second flavor product 332 shown in, at a minimum, FIG. 3C. The method 800 may also include displaying an indication of the second flavor on the package in block 822. The indication of block 822 may be similar to the indication described with respect to block 820 in that the indication may be indicative of the flavor released by the second encapsulated flavor container.

In some examples, exposing the package to the second amount of microwave energy may include releasing a first flavor from at least one of the plurality of encapsulated flavor pouches and releasing a second flavor from another of the plurality of encapsulated flavor pouches.

In some examples, exposing the food item and the package to a first amount of microwave energy may cause the package to display an indication of the first flavor; and exposing the food item and the package to a second amount of microwave energy may cause the package to display an indication of the second flavor.

In this manner, in examples described herein, a user may select a flavor for their microwaved food by selecting a microwave power and/or duration during which the food product is exposed to microwave radiation. If a first flavor is desired, a first power and/or duration may be used, which may result in the release of a certain number of encapsulated flavor pouches, providing a first flavor and/or aroma. If a second flavor is desired, a different power and/or duration may be used, which may result in the release of an additional number of flavor pouches, providing a different flavor and/or aroma. So, for example, if a mild flavor is desired, a first time and/or power may be used to result in the release of a number of flavor pouches (e.g., 0 or 1). If a spicy flavor is desired, a higher power and/or longer time may be used sufficient to release more flavor pouches (e.g., 2 or more) that may provide additional spice flavor to the food. While this example has been described with reference to exemplary numbers of pouches and using the example of spicy flavor, any number of pouches may be used and any flavor and/or aroma additives.

In addition to selecting the intensity of a flavor, in some examples, multiple flavors may be selected. In some examples, if a first flavor, like sweet, is desired, a first power and duration may be used, which may result in the release of a certain number of encapsulated flavor pouches providing this first flavor or aroma. If a spicy flavor is also desired, a different power and/or duration may be used, which may result in the release of a different flavor, for example, spicy, from a different flavor pouch. If only a first flavor is desired, for example sweet, a lower power duration or shorter time may be used. If a second flavor is desired, for example spicy, a longer power duration or longer time may be used. While these examples have been described with reference to a sweet and spicy flavor, any number of pouches and any flavor and/or aroma additives may be used.

The present disclosure is not to be limited in terms of the particular examples described in this application, which are intended as illustrations of various aspects. Many modifications and examples can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and examples are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of“two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

While the foregoing detailed description has set forth various examples of the devices and/or processes via the use of block diagrams, flowcharts, and/or examples, such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof.

The herein described subject matter sometimes illustrates different components contained within, or coupled with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

What is claimed is:

1. An apparatus comprising:
a phase change material (PCM); and
a carrier matrix and a releasable agent dispersed in the carrier matrix, wherein the releasable agent is configured to be released responsive to a phase change of the PCM.

2. The apparatus of claim 1, wherein the carrier matrix comprises calcium carbonate and the PCM comprises cetyl alcohol.

3. The apparatus of claim 1, wherein a quantity of the releasable agent released is dependent on a power level and exposure time of an incident microwave energy delivered to the apparatus.

4. The apparatus of claim 1, wherein a quantity of the releasable agent released is dependent on the amount of energy delivered to the apparatus.

5. The apparatus of claim 1, wherein the releasable agent comprises an aroma product.

6. The apparatus of claim 1, wherein the releasable agent comprises a flavor product.

7. The apparatus of claim 1, wherein the releasable agent comprises a fragrance.

8. The apparatus of claim 1, wherein the apparatus is a cosmetic product.

9. The apparatus of claim 1, wherein the apparatus is a food product.

10. The apparatus of claim 1, further comprising a susceptor configured to heat the PCM responsive to incident microwave energy.

11. The apparatus of claim 1, wherein the PCM contacts a susceptor.

12. The apparatus of claim 1, wherein the PCM comprises at least one of cetyl alcohol, paraffins, waxes, oils, eythitrol, and soy wax.

13. The apparatus of claim 1, further comprising a shell material.

14. The apparatus of claim 13, wherein the shell material comprises a filler matrix.

15. The apparatus of claim 13, wherein the shell material comprises a polymeric material.

16. The apparatus of claim 13, wherein a susceptor is positioned adjacent to an internal surface of the shell material.

17. The apparatus of claim 1, further comprising a thermally conductive component contacting the PCM, wherein the thermally conductive component is configured to enhance a uniformity of the temperature within the PCM.

18. The apparatus of claim 1, further comprising a thermally conductive component configured to disperse heat generated within the PCM responsive to an incident microwave energy.

19. The apparatus of claim 1, wherein the apparatus is a capsule.

20. The apparatus of claim 1, wherein the carrier matrix comprises calcium carbonate.

21. An apparatus comprising:
a shell material;
a phase change material (PCM) at least partially positioned within the shell material;
a susceptor positioned within the shell material and configured to heat the PCM responsive to an incident microwave energy; and
a shield material positioned adjacent the PCM and configured to shield microwave energy and thermally conduct a heat generated in the PCM from the incident microwave energy;
a releasable agent positioned to be at least partially shielded from the incident microwave energy by the shield material and configured to be in thermal communication with the PCM and be released responsive to the phase change of the PCM.

22. An apparatus comprising:
a susceptor positioned adjacent an internal surface of a shell material;
a phase change material (PCM) at least partially contained within the shell material; and
a carrier matrix and a releasable agent dispersed in the carrier matrix, wherein the releasable agent is configured to be released responsive to a phase change of the PCM.

23. An apparatus comprising:
a phase change material (PCM); and
a carrier matrix and a releasable agent dispersed in the carrier matrix, wherein the releasable agent is configured to be released responsive to a phase change of the PCM; and a thermally conductive component configured to disperse heat generated within the PCM responsive to an incident microwave energy.

24. An apparatus to flavor a food item responsive to exposure to microwave energy, the apparatus comprising:
a container with an interior surface, wherein the container is configured to house the food item therein;
a spacer with a first surface and a second surface, wherein the first surface is opposite the second surface, and the first surface of the spacer is adjacent to the interior surface of the container; and
a capsule adjacent the second surface of the spacer, wherein the capsule contains a phase change material that encapsulates a flavor product; and
wherein the flavor product is released from the capsule and directed towards the food item when the phase change material is exposed to a microwave energy to cause a phase change within the phase change material, and wherein a quantity of the flavor product released depends on a power level and an exposure time of the microwave energy delivered to the apparatus during operation.

25. The apparatus of claim 24, further comprising a microwave absorption material located between the first surface of the spacer and the interior surface of the container.

26. The apparatus of claim 24, wherein the capsule has a shell material that defines an aperture and the flavor product is configured to be released from the capsule through the aperture.

27. The apparatus of claim 24, further comprising:
a second capsule adjacent the second surface of the spacer, wherein the second capsule contain a second phase change material that encapsulates a second flavor product; and
wherein the second flavor product is released from the second capsule and directed towards the food item when the second phase change material is exposed to a second microwave energy to cause a phase change within the second phase change material.

28. The apparatus of claim 27, wherein the second flavor product is released after the flavor product is released.

29. The apparatus of claim 24, wherein the phase change material is selected to release the flavor product from the capsule in response to the microwave energy with the power level of at least 1000 Watts and the exposure time of at least 2 minutes.

30. The apparatus of claim 24, wherein the spacer is conductively coupled to the capsule such that thermal dissipation from the spacer to capsule occurs at a prescribed rate.

31. The apparatus of claim 30, wherein the spacer comprises a cardboard material.

32. The apparatus of claim 30, wherein the spacer comprises a material with a thermal conductivity in the range of 0.030 to 0.040 Watts (meter-Kelvin).

33. The apparatus of claim 24, wherein the spacer is configured to absorb the microwave energy and conductively transfer an absorbed energy to the capsule.

34. The apparatus of claim 24, wherein the capsule is configured to absorb a convectively transferred heat from the food item.

35. The apparatus of claim 24, wherein the capsule comprises a microwave reflector material.

36. The apparatus of claim 35, wherein the capsule comprises a convective heat absorption material.

37. The apparatus of claim 35, wherein the capsule comprises a conductive heat absorption material.

38. The apparatus of claim 35, wherein the capsule comprises a material selected from amorphous polyethylene terephthalate, crystallized polyethylene terephthalate, polypropylene, metal, or combinations thereof.

39. The apparatus of claim 24, wherein the phase change material comprises a material selected from paraffin, wax, oil, or combinations thereof.

40. The apparatus of claim 24, wherein the container comprises a second phase change material configured to absorb the microwave energy once the food item has reached a desired temperature.

41. The apparatus of claim 24, wherein a position of the flavor product within the phase change material is selected to result in a staggered release of the flavor product responsive to the microwave energy.

42. A method to manufacture a food flavoring apparatus, the method comprising:
forming a first capsule;
filling the first capsule with a first flavor product encapsulated by a first food-grade phase change material;
coupling a spacer to the first capsule; and
coupling the spacer to an interior surface of a container, wherein the spacer is configured to separate the first capsule from the interior surface of the container.

43. The method of claim 42, further comprising forming the spacer from cardboard.

44. The method of claim 42, further comprising forming the first capsule from microwave reflector material.

45. The method of claim 42, further comprising forming a second capsule;
filling the second capsule with a second flavor product encapsulated by a second food-grade phase change material; and
coupling the second capsule to the spacer.

46. A method of preparing a food item, the method comprising:
placing a package including the food item and an encapsulated flavor container in a microwave oven;
exposing the package to a first amount of microwave energy based on a power level and a time duration when a first flavor is desired for the food item; and
exposing the package to a second amount of microwave energy based on a second power level and a second time duration when a second flavor is desired for the food item.

47. The method of claim 46, wherein exposing the package to the first amount of microwave energy comprises releasing the first flavor from the encapsulated flavor container.

48. The method of claim 47, wherein exposing the package to the second amount of microwave energy comprises releasing the second flavor from the encapsulated flavor container.

49. The method of claim 46, wherein exposing the package to the first amount of microwave energy comprises displaying an indication of the first flavor on the package; and
wherein exposing the package to the second amount of microwave energy comprises displaying an indication of the second flavor on the package.

50. An apparatus to flavor a food item responsive to exposure to microwave energy, the apparatus comprising:
a container with an interior surface, wherein the container is configured to house the food item therein;
a spacer with a first surface and a second surface, wherein the first surface is opposite the second surface, and the first surface of the spacer is adjacent to the interior surface of the container; and
a pouch adjacent the second surface of the spacer and contains a plurality of capsules encapsulated by a phase change material, and each of the plurality of capsules contains a flavor product;
wherein the flavor product is released from the pouch and directed towards the food item when the phase change material is exposed to a microwave energy based on a power level and a time duration to cause the phase change material to change phase, and wherein a quantity of the flavor product released depends on the power level and time duration of the microwave energy delivered to the apparatus during operation.

51. The apparatus of claim 50, wherein each of the plurality of capsules include an inner shell that defines an inner aperture and the flavor product is configured to be released from each capsule into the pouch through the inner aperture.

52. The apparatus of claim 50, wherein the pouch comprises a microwave reflector material.

53. The apparatus of claim 50, wherein the pouch has an outer shell material that defines an outer aperture and the flavor product is configured to be released from the pouch through the outer aperture.

54. The apparatus of claim 53, further comprising a second phase change material that surrounds the outer shell of the pouch.

55. A method to manufacture a food flavoring apparatus, the method comprising:
forming a plurality of capsules;
filling each of the plurality of capsules with a flavor product;
encapsulating each of the plurality of capsules with a food-grade phase change material;
filling a pouch with the plurality of capsules;
coupling a spacer to the pouch; and
coupling the spacer to an interior surface of a container, wherein the spacer is configured to separate the pouch from the interior surface of the container.

56. The method of claim 55, further comprising forming the pouch with an outer shell that defines an outer aperture.

57. The method of claim 55, further comprising forming the pouch using a microwave reflector material.

58. The method of claim 55, wherein forming the plurality of capsules further comprises forming an inner shell that defines an inner aperture.
